(19) United States
(12) Patent Application Publication
(10) Pub. No.: US 2019/0141776 A1
(43) Pub. Date: May 9, 2019

(54) METHOD AND APPARATUS FOR SUSPENDING/RESUMING NAS SIGNALING IN WIRELESS COMMUNICATION SYSTEM

(71) Applicant: LG ELECTRONICS INC., Seoul (KR)

(72) Inventors: Taehun KIM, Seoul (KR); Sangwook HAN, Seoul (KR); Jaehyun KIM, Seoul (KR); Sunyoung LEE, Seoul (KR); Jaewook LEE, Seoul (KR)

(73) Assignee: LG ELECTRONICS INC., Seoul (KR)

(21) Appl. No.: 16/097,195

(22) PCT Filed: Apr. 27, 2017
(86) PCT No.: PCT/KR2017/004504

§ 371 Date: Oct. 26, 2018

Related U.S. Application Data
(60) Provisional application No. 62/328,628, filed on Apr. 28, 2016.
(60) Provisional application No. 62/363,352, filed on Jul. 18, 2016.

(51) Int. Cl. H04W 76/27

(52) U.S. Cl. CPC H04W 76/27; H04W 80/04

(57) ABSTRACT

Disclosed are a method and an apparatus for suspending/resuming NAS signaling in a wireless communication system. Specifically, a method for a user equipment (UE) to suspend/resume non-access stratum (NAS) signaling connection in a wireless communication system comprises: a step in which when a NAS layer of the UE receives, from a radio resource control (RRC) layer, an indication that RRC connection is suspended, the UE enters an evolved packet system (EPS) mobility management (EMM)-idle mode involving a suspension indication; and a step in which when a procedure using a first NAS message is triggered, the RRC layer of the UE is requested to resume the RRC connection, wherein the request comprises a cause of RC establishment and a call type, and when the UE is in a narrow band (NB)-S1 mode, the request may further comprise data volume information of the first NAS message.

### TECHNICAL FIELD

The present invention relates to a wireless communication system and, more particularly, to a method for suspending and resuming non-access stratum (NAS) signaling and an apparatus supporting the same.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### DISCLOSURE

### Technical Problem

An object of the present invention is to propose a method of delivering data volume information from an NAS layer to an access stratum (AS) layer so that the AS layer of a terminal can transmit a data volume indicator through a third message (Msg3) when suspended NAS signaling is resumed.

Technical objects to be achieved in the present invention are not limited to the aforementioned technical objects, and other technical objects not described above may be evidently understood by a person having ordinary skill in the art to which the present invention pertains from the following description.

### Technical Solution

In an aspect of the present invention, a method for a user equipment (UE) to suspend and resume a non-access stratum (NAS) signaling connection in a wireless communication system includes entering, by the UE, an evolved packet system (EPS) mobility management (EMM)-IDLE mode with suspend indication when an NAS layer of the UE receives indication informing that an RRC connection has been suspended from a radio resource control (RRC) layer and requesting resume of an RRC connection from the RRC layer of the UE when a procedure using an initial NAS message is triggered. The request includes an RRC establishment cause and a call type. When the UE is a narrow band (NB)-S1 mode, the request may further include data volume information of the NAS message.

In another aspect of the present invention, a user equipment (UE) for suspending/resuming a non-access stratum (NAS) signaling connection in a wireless communication system includes a communication module for transmitting and receiving signals and a processor controlling the communication module. The processor is configured to enter an evolved packet system (EPS) mobility management (EMM)-IDLE mode with suspend indication when an NAS layer of the UE receives indication informing that an RRC connection has been suspended from a radio resource control (RRC) layer and request resume of an RRC connection from the RRC layer of the UE when a procedure using an initial NAS message is triggered. The request includes an RRC establishment cause and a call type. When the UE is a narrow band (NB)-S1 mode, the request may further include data volume information of the NAS message.

Preferably, the initial NAS message may include a first message for transmitting data over a control plane.

Preferably, the data volume information may indicate the size of the data or the size of the initial NAS message.

Preferably, the data volume information may indicate the size of an ESM message container including an EPS session management (ESM) message or the size of an SMS message container including a short message service (SMS) message within the first message.

Preferably, while the UE is the EMM-IDLE mode with suspend indication, when the indication informing that the RRC connection has been resumed is received from the RRC layer, the UE may enter an EMM-CONNECTED mode.

Preferably, if the initial NAS message is a service request message, the initial NAS message may not be delivered to the RRC layer.

Preferably, if the initial NAS message is not a service request message, the initial NAS message may be delivered to the RRC layer.

Preferably, while the UE is the EMM-IDLE mode with suspend indication, when indication informing that the resume of the RRC connection has been fallen back is received from the RRC layer, the UE may enter an EMM-IDLE mode without suspend indication.

Preferably, the initial NAS message may be delivered to the RRC layer.

Preferably, when indication informing that the resume of the RRC connection has failed and indication informing that the RRC connection is to be suspended are received from the RRC layer, the UE may enter the EMM-IDLE mode with suspend indication.

Preferably, when indication informing that the resume of the RRC connection has failed and indication informing that the RRC connection is not suspended are received from the RRC layer, the UE may enter an EMM-IDLE mode without suspend indication.

### Advantageous Effects

In accordance with an embodiment of the present invention, transmission latency for the initial NAS message of a terminal can be reduced because a data volume indicator is transmitted through a third message (Msg 3).

Furthermore, in accordance with an embodiment of the present invention, signaling overhead between a terminal and a base station for transmitting the initial NAS message of the terminal can be reduced because a data volume indicator is transmitted through a third message (Msg 3).

Effects which may be obtained in the present invention are not limited to the aforementioned effects, and other technical effects not described above may be evidently understood by a person having ordinary skill in the art to which the present invention pertains from the following description.

### DESCRIPTION OF DRAWINGS

The accompanying drawings, which are included to provide a further understanding of the present invention and constitute a part of specifications of the present invention, illustrate embodiments of the present invention and together with the corresponding descriptions serve to explain the principles of the present invention.

FIG. 1 is a diagram schematically exemplifying an evolved packet system (EPS) to which the present invention can be applied.

FIG. 2 illustrates an example of evolved universal terrestrial radio access network structure to which the present invention can be applied.

FIG. 3 exemplifies a structure of E-UTRAN and EPC in a wireless communication system to which the present invention can be applied.

FIG. 4 illustrates a structure of a radio interface protocol between a UE and E-UTRAN in a wireless communication system to which the present invention can be applied.

FIG. 5 is a diagram schematically showing a structure of a physical channel in a wireless communication system to which the present invention may be applied.

FIG. 6 is a diagram for describing a contention based random access procedure in a wireless communication system to which the present invention may be applied.

FIG. 7 illustrates a procedure for small data transmission in a wireless communication system to which the present invention may be applied.

FIG. 8 illustrates a procedure for a data volume report and small data transmission in a wireless communication system to which the present invention may be applied.

FIG. 9 illustrates a connection suspend procedure initiated by a base station in a wireless communication system to which the present invention may be applied.

FIG. 10 illustrates a connection resume procedure initiated by a terminal in a wireless communication system to which the present invention may be applied.

FIG. 11 illustrates an RRC connection resume procedure in a wireless communication system to which the present invention may be applied.

FIG. 12 is a diagram for illustrating problems of a connection resume procedure in a wireless communication system to which the present invention may be applied.

FIG. 13 is a diagram illustrating a method for a UE to suspend/resume NAS signaling according to an embodiment of the present invention.

FIG. 14 illustrates a block configuration of a communication apparatus according to an embodiment of the present invention.

FIG. 15 illustrates a block configuration of a communication apparatus according to an embodiment of the present invention.

### MODE FOR INVENTION

In what follows, preferred embodiments according to the present invention will be described in detail with reference to appended drawings. The detailed descriptions provided below together with appended drawings are intended only to explain illustrative embodiments of the present invention, which should not be regarded as the sole embodiments of the present invention. The detailed descriptions below include specific information to provide complete understanding of the present invention. However, those skilled in the art will be able to comprehend that the present invention may be embodied without the specific information.

For some cases, to avoid obscuring the technical principles of the present invention, structures and devices well-known to the public may be omitted or may be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by an upper node of the base station depending on situations. In other words, it is apparent that in a network consisting of a plurality of network nodes including a base station, various operations performed for communication with a UE may be performed by the base station or by network nodes other than the base station. The term Base Station (BS) may be replaced with a fixed station, Node B, evolved-NodeB (eNB), Base Transceiver System (BTS), or Access Point (AP). Also, a terminal may be fixed or mobile; and the term may be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter may be part of the base station, and a receiver may be part of the terminal. Similarly, in uplink transmission, a transmitter may be part of the terminal, and a receiver may be part of the base station.

Specific terms used in the following descriptions are introduced to help understanding the present invention, and the specific terms may be used in different ways as long as it does not leave the technical scope of the present invention.

The technology described below may be used for various types of wireless access systems based on Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), or Non-Orthogonal Multiple Access (NOMA). CDMA may be implemented by such radio technology as Universal Terrestrial Radio Access (UTRA) or CDMA2000. TDMA may be implemented by such radio technology as Global System for Mobile communications (GSM), General Packet Radio Service (GPRS), or Enhanced Data rates for GSM Evolution (EDGE). OFDMA may be implemented by such radio technology as the IEEE 802.11 (Wi-Fi), the IEEE 802.16 (WiMAX), the IEEE 802-20, or Evolved UTRA (E-UTRA). UTRA is part of the Universal Mobile Telecommunications System (UMTS). The 3rd Generation Partnership Project (3GPP) Long Term Evolution (LTE) is part of the Evolved UMTS (E-UMTS) which uses the E-UTRA, employing OFDMA for downlink and SC-FDMA for uplink transmission. The LTE-A (Advanced) is an evolved version of the 3GPP LTE system.

Embodiments of the present invention may be supported by standard documents disclosed in at least one of wireless access systems including the IEEE 802, 3GPP, and 3GPP2 specifications. In other words, among the embodiments of the present invention, those steps or parts omitted for the purpose of clearly describing technical principles of the present invention may be supported by the documents above. Also, all of the terms disclosed in this document may be explained with reference to the standard documents.

To clarify the descriptions, this document is based on the 3GPP LTE/LTE-A, but the technical features of the present invention are not limited to the current descriptions.

Terms used in this document are defined as follows.
Universal Mobile Telecommunication System (UMTS): the 3rd generation mobile communication technology based on GSM, developed by the 3GPP
Evolved Packet System (EPS): a network system comprising an Evolved Packet Core (EPC), a packet switched core network based on the Internet Protocol (IP) and an access network such as the LTE and UTRAN. The EPS is a network evolved from the UMTS.
NodeB: the base station of the UMTS network. NodeB is installed outside and provides coverage of a macro cell.
eNodeB: the base station of the EPS network. eNodeB is installed outside and provides coverage of a macro cell.
User Equipment (UE): A UE may be called a terminal, Mobile Equipment (ME), or Mobile Station (MS). A UE may be a portable device such as a notebook computer, mobile phone, Personal Digital Assistant (PDA), smart phone, or a multimedia device; or a fixed device such as a Personal Computer (PC) or vehicle-mounted device. The term UE may refer to an MTC terminal in the description related to MTC.
IP Multimedia Subsystem (IMS): a sub-system providing multimedia services based on the IP
International Mobile Subscriber Identity (IMSI): a globally unique subscriber identifier assigned in a mobile communication network
Machine Type Communication (MTC): communication performed by machines without human intervention. It may be called Machine-to-Machine (M2M) communication.
MTC terminal (MTC UE or MTC device): a terminal (for example, a vending machine, meter, and so on) equipped with a communication function operating through a mobile communication network (For example, communicating with an MTC server via a PLMN) and performing an MTC function
MTC server: a server on a network managing MTC terminals. It may be installed inside or outside a mobile communication network. It may provide an interface through which an MTC user may access the server. Also, an MTC server may provide MTC-related services to other servers (in the form of Services Capability Server (SCS)) or the MTC server itself may be an MTC Application Server.
(MTC) application: services (to which MTC is applied) (for example, remote metering, traffic movement tracking, weather observation sensors, and so on)
(MTC) Application Server: a server on a network in which (MTC) applications are performed
MTC feature: a function of a network to support MTC applications. For example, MTC monitoring is a feature intended to prepare for loss of a device in an MTC application such as remote metering, and low mobility is a feature intended for an MTC application with respect to an MTC terminal such as a vending machine.
MTC User (MTC User): The MTC user uses the service provided by the MTC server.
MTC subscriber: an entity having a connection relationship with a network operator and providing services to one or more MTC terminals.
MTC group: an MTC group shares at least one or more MTC features and denotes a group of MTC terminals belonging to MTC subscribers.
Services Capability Server (SCS): an entity being connected to the 3GPP network and used for communicating with an MTC InterWorking Function (MTC-IWF) on a Home PLMN (HPLMN) and an MTC terminal. The SCS provides the capability for use by one or more MTC applications.
External identifier: a globally unique identifier used by an external entity (for example, an SCS or an Application Server) of the 3GPP network to indicate (or identify) an MTC terminal (or a subscriber to which the MTC terminal belongs). An external identifier includes a domain identifier and a local identifier as described below.
Domain identifier: an identifier used for identifying a domain in the control region of a mobile communication network service provider. A service provider may use a separate domain identifier for each service to provide an access to a different service.
Local identifier: an identifier used for deriving or obtaining an International Mobile Subscriber Identity (IMSI). A local identifier should be unique within an application domain and is managed by a mobile communication network service provider.
Radio Access Network (RAN): a unit including a Node B, a Radio Network Controller (RNC) controlling the Node B, and an eNodeB in the 3GPP network. The RAN is defined at the terminal level and provides a connection to a core network.
Home Location Register (HLR)/Home Subscriber Server (HSS): a database provisioning subscriber information within the 3GPP network. An HSS may perform functions of configuration storage, identity management, user state storage, and so on.
RAN Application Part (RANAP): an interface between the RAN and a node in charge of controlling a core network (in other words, a Mobility Management Entity (MME)/Serving GPRS (General Packet Radio Service) Supporting Node (SGSN)/Mobile Switching Center (MSC)).
Public Land Mobile Network (PLMN): a network formed to provide mobile communication services to individuals. The PLMN may be formed separately for each operator.
Service Capability Exposure Function (SCEF): An entity within the 3GPP architecture for service capability exposure that provides a means for securely exposing services and capabilities provided by 3GPP network interfaces.

In what follows, the present invention will be described based on the terms defined above.

Overview of System to which the Present Invention May be Applied

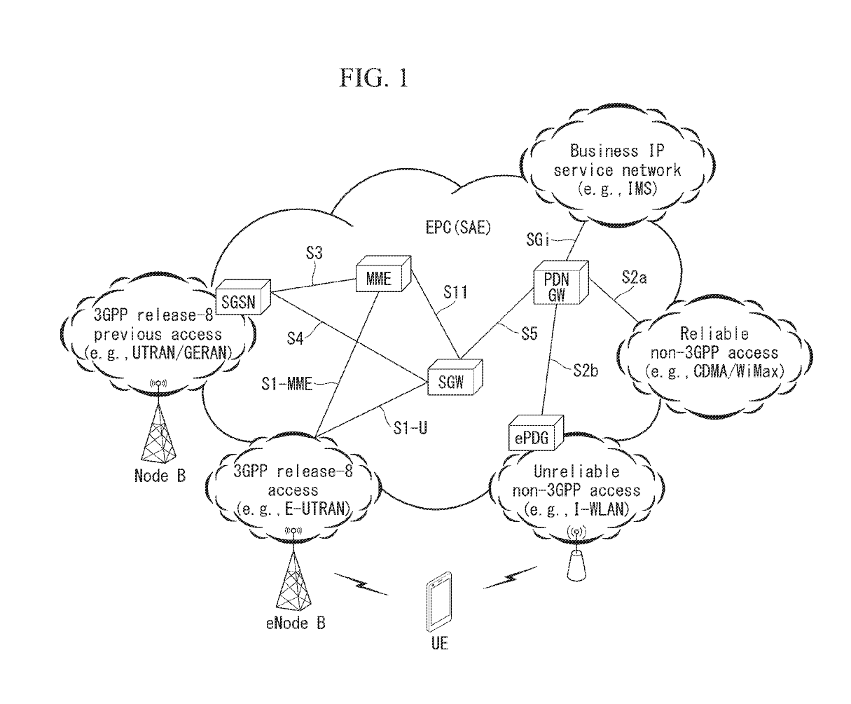

FIG. 1 illustrates an Evolved Packet System (EPS) to which the present invention may be applied.

The network structure of FIG. 1 is a simplified diagram restructured from an Evolved Packet System (EPS) including Evolved Packet Core (EPC).

The EPC is a main component of the System Architecture Evolution (SAE) intended for improving performance of the 3GPP technologies. SAE is a research project for determining a network structure supporting mobility between multiple heterogeneous networks. For example, SAE is intended to provide an optimized packet-based system which supports various IP-based wireless access technologies, provides much more improved data transmission capability, and so on.

More specifically, the EPC is the core network of an IP-based mobile communication system for the 3GPP LTE system and capable of supporting packet-based real-time and non-real time services. In the existing mobile communication systems (namely, in the 2nd or 3rd mobile communication system), functions of the core network have been implemented through two separate sub-domains: a Circuit-Switched (CS) sub-domain for voice and a Packet-Switched (PS) sub-domain for data. However, in the 3GPP LTE system, an evolution from the 3rd mobile communication system, the CS and PS sub-domains have been unified into a single IP domain. In other words, in the 3GPP LTE system, connection between UEs having IP capabilities may be established through an IP-based base station (for example, eNodeB), EPC, and application domain (for example, IMS). In other words, the EPC provides the architecture essential for implementing end-to-end IP services.

The EPC includes various components, where FIG. 1 illustrates part of the EPC components, including a Serving Gateway (SGW or S-GW), Packet Data Network Gateway (PDN GW or PGW or P-GW), Mobility Management Entity (MME), Serving GPRS Supporting Node (SGSN), and enhanced Packet Data Gateway (ePDG).

The SGW operates as a boundary point between the Radio Access Network (RAN) and the core network and maintains a data path between the eNodeB and the PDN GW. Also, if UE moves across serving areas by the eNodeB, the SGW acts as an anchor point for local mobility. In other words, packets may be routed through the SGW to ensure mobility within the E-UTRAN (Evolved-UMTS (Universal Mobile Telecommunications System) Terrestrial Radio Access Network defined for the subsequent versions of the 3GPP release 8). Also, the SGW may act as an anchor point for mobility between the E-UTRAN and other 3GPP networks (the RAN defined before the 3GPP release 8, for example, UTRAN or GERAN (GSM (Global System for Mobile Communication)/EDGE (Enhanced Data rates for Global Evolution) Radio Access Network).

The PDN GW corresponds to a termination point of a data interface to a packet data network. The PDN GW may support policy enforcement features, packet filtering, charging support, and so on. Also, the PDN GW may act as an anchor point for mobility management between the 3GPP network and non-3GPP networks (for example, an unreliable network such as the Interworking Wireless Local Area Network (I-WLAN) or reliable networks such as the Code Division Multiple Access (CDMA) network and WiMax).

In the example of a network structure as shown in FIG. 1, the SGW and the PDN GW are treated as separate gateways; however, the two gateways may be implemented according to single gateway configuration option.

The MME performs signaling for the UE's access to the network, supporting allocation, tracking, paging, roaming, handover of network resources, and so on; and control functions. The MME controls control plane functions related to subscribers and session management. The MME manages a plurality of eNodeBs and performs signaling of the conventional gateway's selection for handover to other 2G/3G networks. Also, the MME performs such functions as security procedures, terminal-to-network session handling, idle terminal location management, and so on.

The SGSN deals with all kinds of packet data including the packet data for mobility management and authentication of the user with respect to other 3GPP networks (for example, the GPRS network).

The ePDG acts as a security node with respect to an unreliable, non-3GPP network (for example, I-WLAN, WiFi hotspot, and so on).

As described with respect to FIG. 1, a UE with the IP capability may access the IP service network (for example, the IMS) that a service provider (namely, an operator) provides, via various components within the EPC based not only on the 3GPP access but also on the non-3GPP access.

Also, FIG. 1 illustrates various reference points (for example, S1-U, S1-MME, and so on). The 3GPP system defines a reference point as a conceptual link which connects two functions defined in disparate functional entities of the E-UTAN and the EPC. Table 1 below summarizes reference points shown in FIG. 1. In addition to the examples of FIG. 1, various other reference points may be defined according to network structures.

TABLE 1

| Reference | |
|---|---|
| point | Description |
| S1-MME | Reference point for the control plane protocol between |
| | E-UTRAN and MME |
| S1-U | Reference point between E-UTRAN and Serving GW for the |
| | per bearer user plane tunneling and inter eNodeB path |
| | switching during handover |
| S3 | It enables user and bearer information exchange for |
| | inter 3GPP access network mobility in idle and/or active |
| | state. This reference point may be used intra-PLMN or |
| | inter-PLMN (e.g. in the case of Inter-PLMN HO). |
| S4 | It provides related control and mobility support between |
| | GPRS core and the 3GPP anchor function of Serving GW. In |
| | addition, if direct tunnel is not established, it provides |
| | the user plane tunneling. |
| S5 | It provides user plane tunneling and tunnel management |
| | between Serving GW and PDN GW. It is used for Serving |
| | GW relocation due to UE mobility if the Serving GW needs |
| | to connect to a non-collocated PDN GW for the required |
| | PDN connectivity. |
| S11 | Reference point for the control plane protocol between |
| | MME and SGW |
| SGi | It is the reference point between the PDN GW and the packet |
| | data network. Packet data network may be an operator |
| | external public or private packet data network or an intra- |
| | operator packet data network (e.g., for provision of IMS |
| | services). This reference point corresponds to Gi for |
| | 3GPP accesses. |

Among the reference points shown in FIG. 1, S2a and S2b corresponds to non-3GPP interfaces. S2a is a reference point which provides reliable, non-3GPP access, related control between PDN GWs, and mobility resources to the user plane. S2b is a reference point which provides related control and mobility resources to the user plane between ePDG and PDN GW.

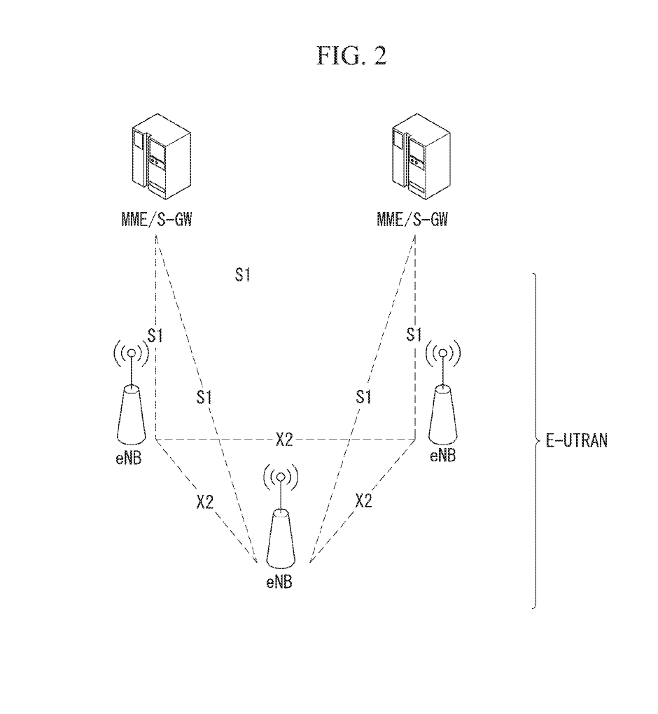

FIG. 2 illustrates one example of an Evolved Universal Terrestrial Radio Access Network (E-UTRAN) to which the present invention may be applied.

The E-UTRAN system is an evolved version of the existing UTRAN system, for example, and is also referred to as 3GPP LTE/LTE-A system. Communication network is widely deployed in order to provide various communication services such as voice (e.g., Voice over Internet Protocol (VoIP)) through IMS and packet data.

Referring to FIG. 2, E-UMTS network includes E-UTRAN, EPC and one or more UEs. The E-UTRAN includes eNBs that provide control plane and user plane protocol, and the eNBs are interconnected with each other by means of the X2 interface.

The X2 user plane interface (X2-U) is defined among the eNBs. The X2-U interface provides non-guaranteed delivery of the user plane Packet Data Unit (PDU). The X2 control plane interface (X2-CP) is defined between two neighboring eNBs. The X2-CP performs the functions of context delivery between eNBs, control of user plane tunnel between a source eNB and a target eNB, delivery of handover-related messages, uplink load management, and so on.

The eNB is connected to the UE through a radio interface and is connected to the Evolved Packet Core (EPC) through the S1 interface.

The S1 user plane interface (S1-U) is defined between the eNB and the Serving Gateway (S-GW). The S1 control plane interface (S1-MME) is defined between the eNB and the Mobility Management Entity (MME). The S1 interface performs the functions of EPS bearer service management, non-access stratum (NAS) signaling transport, network sharing, MME load balancing management, and so on. The S1 interface supports many-to-many-relation between the eNB and the MME/S-GW.

The MME may perform various functions such as NAS signaling security, Access Stratum (AS) security control, Core Network (CN) inter-node signaling for supporting mobility between 3GPP access network, IDLE mode UE reachability (including performing paging retransmission and control), Tracking Area Identity (TAI) management (for UEs in idle and active mode), selecting PDN GW and SGW, selecting MME for handover of which the MME is changed, selecting SGSN for handover to 2G or 3G 3GPP access network, roaming, authentication, bearer management function including dedicated bearer establishment, Public Warning System (PWS) (including Earthquake and Tsunami Warning System (ETWS) and Commercial Mobile Alert System (CMAS), supporting message transmission and so on.

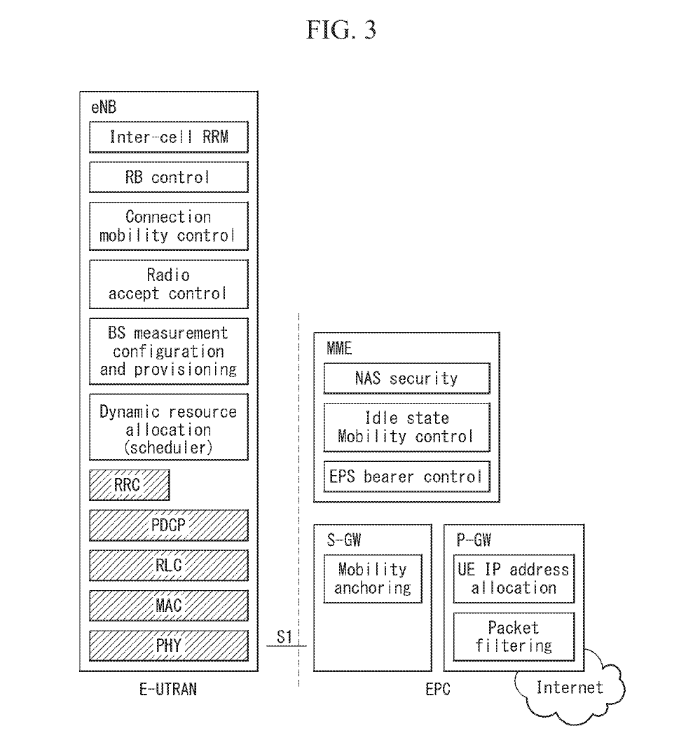

FIG. 3 exemplifies a structure of E-UTRAN and EPC in a wireless communication system to which the present invention may be applied.

Referring to FIG. 3, an eNB may perform functions of selecting gateway (e.g., MME), routing to gateway during radio resource control (RRC) is activated, scheduling and transmitting broadcast channel (BCH), dynamic resource allocation to UE in uplink and downlink, mobility control connection in LTE_ACTIVE state. As described above, the gateway in EPC may perform functions of paging origination, LTE_IDLE state management, ciphering of user plane, bearer control of System Architecture Evolution (SAE), ciphering of NAS signaling and integrity protection.

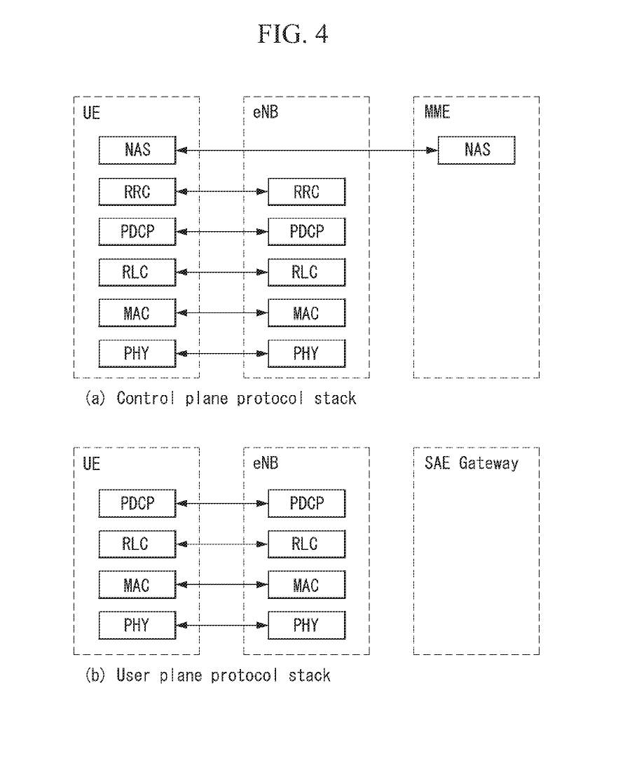

FIG. 4 illustrates a radio interface protocol structure between a UE and an E-UTRAN in a wireless communication system to which the present invention may be applied.

FIG. 4(a) illustrates a radio protocol structure for the control plane, and FIG. 4(b) illustrates a radio protocol structure for the user plane.

Referring to FIG. 4, layers of the radio interface protocol between the UE and the E-UTRAN may be divided into a first layer (L1), a second layer (L2), and a third layer (L3) based on the lower three layers of the Open System Interconnection (OSI) model, widely known in the technical field of communication systems. The radio interface protocol between the UE and the E-UTRAN consists of the physical layer, data link layer, and network layer in the horizontal direction, while in the vertical direction, the radio interface protocol consists of the user plane, which is a protocol stack for delivery of data information, and the control plane, which is a protocol stack for delivery of control signals.

The control plane acts as a path through which control messages used for the UE and the network to manage calls are transmitted. The user plane refers to the path through which the data generated in the application layer, for example, voice data, Internet packet data, and so on are transmitted. In what follows, described will be each layer of the control and the user plane of the radio protocol.

The physical layer (PHY), which is the first layer (L1), provides information transfer service to upper layers by using a physical channel. The physical layer is connected to the Medium Access Control (MAC) layer located at the upper level through a transport channel through which data are transmitted between the MAC layer and the physical layer. Transport channels are classified according to how and with which features data are transmitted through the radio interface. And data are transmitted through the physical channel between different physical layers and between the physical layer of a transmitter and the physical layer of a receiver. The physical layer is modulated according to the Orthogonal Frequency Division Multiplexing (OFDM) scheme and employs time and frequency as radio resources.

A few physical control channels are used in the physical layer. The Physical Downlink Control Channel (PDCCH) informs the UE of resource allocation of the Paging Channel (PCH) and the Downlink Shared Channel (DL-SCH); and Hybrid Automatic Repeat reQuest (HARQ) information related to the Uplink Shared Channel (UL-SCH). Also, the PDCCH may carry a UL grant used for informing the UE of resource allocation of uplink transmission. The Physical Control Format Indicator Channel (PCFICH) informs the UE of the number of OFDM symbols used by PDCCHs and is transmitted at each subframe. The Physical HARQ Indicator Channel (PHICH) carries a HARQ ACK (ACKnowledge)/NACK (Non-ACKnowledge) signal in response to uplink transmission. The Physical Uplink Control Channel (PUCCH) carries uplink control information such as HARQ ACK/NACK with respect to downlink transmission, scheduling request, Channel Quality Indicator (CQI), and so on. The Physical Uplink Shared Channel (PUSCH) carries the UL-SCH.

The MAC layer of the second layer (L2) provides a service to the Radio Link Control (RLC) layer, which is an upper layer thereof, through a logical channel. Also, the MAC layer provides a function of mapping between a logical channel and a transport channel; and multiplexing/demultiplexing a MAC Service Data Unit (SDU) belonging to the logical channel to the transport block, which is provided to a physical channel on the transport channel.

The RLC layer of the second layer (L2) supports reliable data transmission. The function of the RLC layer includes concatenation, segmentation, reassembly of the RLC SDU, and so on. To satisfy varying Quality of Service (QoS) requested by a Radio Bearer (RB), the RLC layer provides three operation modes: Transparent Mode (TM), Unacknowledged Mode (UM), and Acknowledge Mode (AM). The AM RLC provides error correction through Automatic Repeat reQuest (ARQ). Meanwhile, if MAC layer performs the RLC function, the RLC layer may be incorporated into the MAC layer as a functional block.

The Packet Data Convergence Protocol (PDCP) layer of the second layer (L2) performs the function of delivering, header compression, ciphering of user data in the user plane, and so on. Header compression refers to the function of reducing the size of the Internet Protocol (IP) packet header which is relatively large and contains unnecessary control to efficiently transmit IP packets such as the IPv4 (Internet Protocol version 4) or IPv6 (Internet Protocol version 6) packets through a radio interface with narrow bandwidth. The function of the PDCP layer in the control plane includes delivering control plane data and ciphering/integrity protection.

The Radio Resource Control (RRC) layer in the lowest part of the third layer (L3) is defined only in the control plane. The RRC layer performs the role of controlling radio resources between the UE and the network. To this purpose, the UE and the network exchange RRC messages through the RRC layer. The RRC layer controls a logical channel, transport channel, and physical channel with respect to configuration, re-configuration, and release of radio bearers. A radio bearer refers to a logical path that the second layer (L2) provides for data transmission between the UE and the network. Configuring a radio bearer indicates that characteristics of a radio protocol layer and channel are defined to provide specific services; and each individual parameter and operating methods thereof are determined. Radio bearers may be divided into Signaling Radio Bearers (SRBs) and Data RBs (DRBs). An SRB is used as a path for transmitting an RRC message in the control plane, while a DRB is used as a path for transmitting user data in the user plane.

The Non-Access Stratum (NAS) layer in the upper of the RRC layer performs the function of session management, mobility management, and so on.

A cell constituting the base station is set to one of 1.25, 2.5, 5, 10, and 20 MHz bandwidth, providing downlink or uplink transmission services to a plurality of UEs. Different cells may be set to different bandwidths.

Downlink transport channels transmitting data from a network to a UE include a Broadcast Channel (BCH) transmitting system information, PCH transmitting paging messages, DL-SCH transmitting user traffic or control messages, and so on. Traffic or a control message of a downlink multi-cast or broadcast service may be transmitted through the DL-SCH or through a separate downlink Multicast Channel (MCH). Meanwhile, uplink transport channels transmitting data from a UE to a network include a Random Access Channel (RACH) transmitting the initial control message and a Uplink Shared Channel (UL-SCH) transmitting user traffic or control messages.

Logical channels, which are located above the transport channels and are mapped to the transport channels. The logical channels may be distinguished by control channels for delivering control area information and traffic channels for delivering user area information. The control channels include a Broadcast Control Channel (BCCH), a Paging Control Channel (PCCH), a Common Control Channel (CCCH), a dedicated control channel (DCCH), a Multicast Control Channel (MCCH), and etc. The traffic channels include a dedicated traffic channel (DTCH), and a Multicast Traffic Channel (MTCH), etc. The PCCH is a downlink channel that delivers paging information, and is used when network does not know the cell where a UE belongs. The CCCH is used by a UE that does not have RRC connection with network. The MCCH is a point-to-multipoint downlink channel which is used for delivering Multimedia Broadcast and Multicast Service (MBMS) control information from network to UE. The DCCH is a point-to-point bi-directional channel which is used by a UE that has RRC connection delivering dedicated control information between UE and network. The DTCH is a point-to-point channel which is dedicated to a UE for delivering user information that may be existed in uplink and downlink. The MTCH is a point-to-multipoint downlink channel for delivering traffic data from network to UE.

In case of uplink connection between the logical channel and the transport channel, the DCCH may be mapped to UL-SCH, the DTCH may be mapped to UL-SCH, and the CCCH may be mapped to UL-SCH. In case of downlink connection between the logical channel and the transport channel, the BCCH may be mapped to BCH or DL-SCH, the PCCH may be mapped to PCH, the DCCH may be mapped to DL-SCH, the DTCH may be mapped to DL-SCH, the MCCH may be mapped to MCH, and the MTCH may be mapped to MCH.

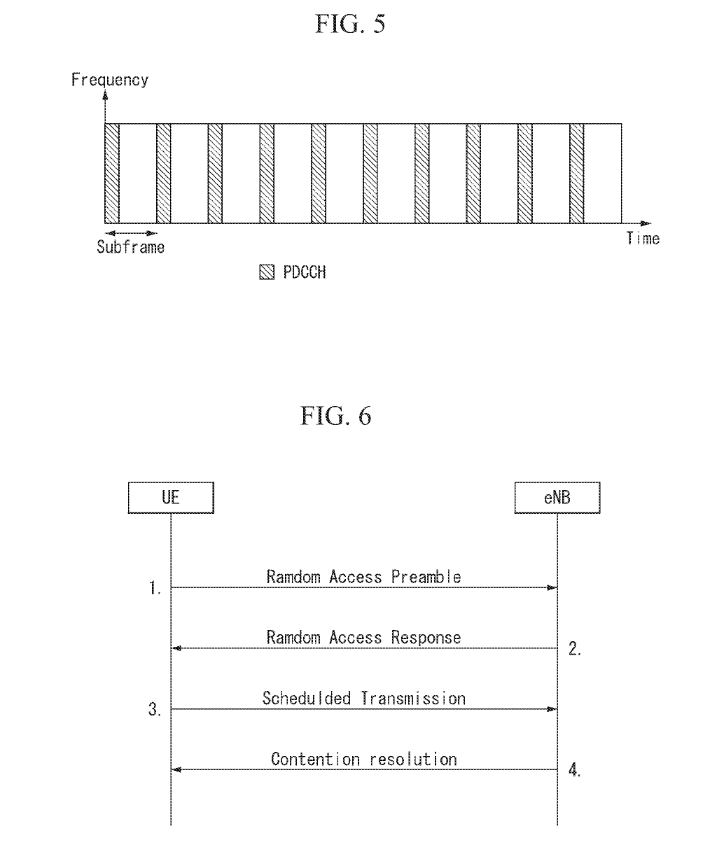

FIG. 5 is a diagram schematically exemplifying a structure of physical channel in a wireless communication system to which the present invention may be applied.

Referring to FIG. 5, the physical channel delivers signaling and data through radio resources including one or more subcarriers in frequency domain and one or more symbols in time domain.

One subframe that has a length of 1.0 ms includes a plurality of symbols. A specific symbol (s) of subframe (e.g., the first symbol of subframe) may be used for PDCCH. The PDCCH carries information for resources which are dynamically allocated (e.g., resource block, modulation and coding scheme (MCS), etc.).

Random Access Procedure

Hereinafter, a random access procedure which is provided in a LTE/LTE-A system will be described.

The random access procedure is performed in case that the UE performs an initial access in a RRC idle state without any RRC connection to an eNB, or the UE performs a RRC connection re-establishment procedure, etc.

The LTE/LTE-A system provides both of the contention-based random access procedure that the UE randomly selects to use one preamble in a specific set and the non-contention-based random access procedure that the eNB uses the random access preamble that is allocated to a specific UE.

FIG. 6 is a diagram for describing the contention-based random access procedure in the wireless communication system to which the present invention may be applied.

(1) Message 1 (Msg 1)

First, the UE randomly selects one random access preamble (RACH preamble) from the set of the random access preamble that is instructed through system information or handover command, selects and transmits physical RACH (PRACH) resource which is able to transmit the random access preamble.

The eNB that receives the random access preamble from the UE decodes the preamble and acquires RA-RNTI. The RA-RNTI associated with the PRACH to which the random access preamble is transmitted is determined according to the time-frequency resource of the random access preamble that is transmitted by the corresponding UE.

(2) Message 2 (Msg 2)

The eNB transmits the random access response that is addressed to RA-RNTI that is acquired through the preamble on the Msg 1 to the UE. The random access response may include RA preamble index/identifier, UL grant that informs the UL radio resource, temporary cell RNTI (TC-RNTI), and time alignment command (TAC). The TAC is the information indicating a time synchronization value that is transmitted by the eNB in order to keep the UL time alignment. The UE renews the UL transmission timing using the time synchronization value. On the renewal of the time synchronization value, the UE renews or restarts the time alignment timer. The UL grant includes the UL resource allocation that is used for transmission of the scheduling message to be described later (Message 3) and the transmit power command (TPC). The TCP is used for determination of the transmission power for the scheduled PUSCH.

The UE, after transmitting the random access preamble, tries to receive the random access response of its own within the random access response window that is instructed by the eNB with system information or handover command, detects the PDCCH masked with RA-RNTI that corresponds to PRACH, and receives the PDSCH that is indicated by the detected PDCCH. The random access response information may be transmitted in a MAC packet data unit and the MAC PDU may be delivered through PDSCH.

The UE terminates monitoring of the random access response if successfully receiving the random access response having the random access preamble index/identifier same as the random access preamble that is transmitted to the eNB. Meanwhile, if the random access response message has not been received until the random access response window is terminated, or if not received a valid random access response having the random access preamble index same as the random access preamble that is transmitted to the eNB, it is considered that the receipt of random access response is failed, and after that, the UE may perform the retransmission of preamble.

(3) Message 3 (Msg 3)

In case that the UE receives the random access response that is effective with the UE itself, the UE processes the information included in the random access response respectively. That is, the UE applies TAC and stores TC-RNTI. Also, by using UL grant, the UE transmits the data stored in the buffer of UE or the data newly generated to the eNB.

In case of the initial access of UE, the RRC connection request that is delivered through CCCH after generating in RRC layer may be transmitted with being included in the message 3. In case of the RRC connection reestablishment procedure, the RRC connection reestablishment request that is delivered through CCCH after generating in RRC layer may be transmitted with being included in the message 3. Additionally, NAS access request message may be included.

The message 3 should include the identifier of UE. There are two ways how to include the identifier of UE. The first method is that the UE transmits the cell RNTI (C-RNTI) of its own through the UL transmission signal corresponding to the UL grant, if the UE has a valid C-RNTI that is already allocated by the corresponding cell before the random access procedure. Meanwhile, if the UE has not been allocated a valid C-RNTI before the random access procedure, the UE transmits including unique identifier of its own (for example, SAE temporary mobile subscriber identity (S-TMSI) or random number). Normally the above unique identifier is longer that C-RNTI.

If transmitting the data corresponding to the UL grant, the UE initiates a contention resolution timer.

(4) Message 4 (Msg 4)

The eNB, in case of receiving the C-RNTI of corresponding UE through the message 3 from the UE, transmits the message 4 to the UE by using the received C-RNTI. Meanwhile, in case of receiving the unique identifier (that is, S-TMSI or random number) through the message 3 from the UE, the eNB transmits the 4 message to the UE by using the TC-RNTI that is allocated from the random access response to the corresponding UE. For example, the 4 message may include the RRC connection setup message.

The UE waits for the instruction of eNB for collision resolution after transmitting the data including the identifier of its own through the UL grant included the random access response. That is, the UE attempts the receipt of PDCCH in order to receive a specific message. There are two ways how to receive the PDCCH. As previously mentioned, in case that the message 3 transmitted in response to the UL grant includes C-RNTI as an identifier of its own, the UE attempts the receipt of PDCCH using the C-RNTI of itself, and in case that the above identifier is the unique identifier (that is, S-TMSI or random number), the UE tries to receive PDCCH using the TC-RNTI that is included in the random access response. After that, in the former case, if the PDCCH is received through the C-RNTI of its own before the contention resolution timer is terminated, the UE determines that the random access procedure is performed and terminates the procedure. In the latter case, if the PDCCH is received through the TC-RNTI before the contention resolution timer is terminated, the UE checks on the data that is delivered by PDSCH, which is addressed by the PDCCH. If the content of the data includes the unique identifier of its own, the UE terminates the random access procedure determining that a normal procedure has been performed. The UE acquires C-RNTI through the 4 message, and after that, the UE and network are to transmit and receive a UE-specific message by using the C-RNTI.

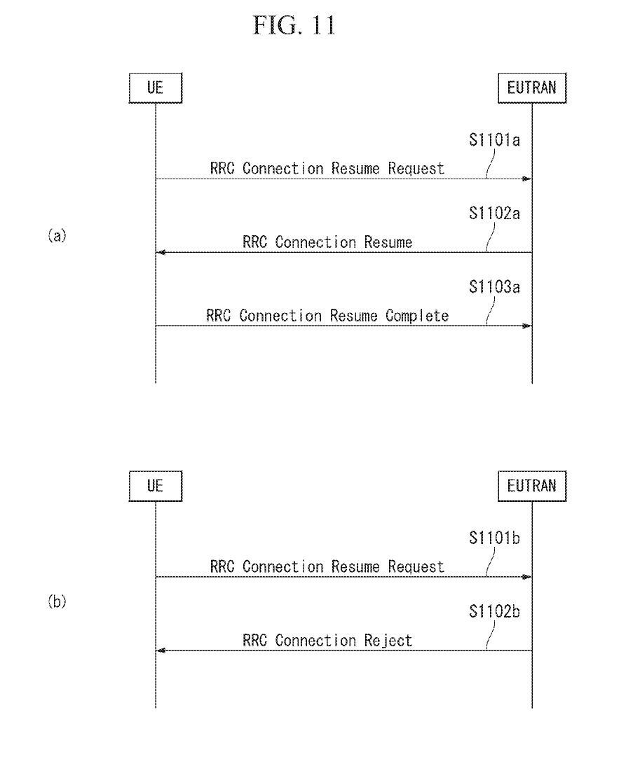

Meanwhile, the operation of the non-contention-based random access procedure, unlike the contention-based random access procedure illustrated in FIG. 11, is terminated with the transmission of message 1 and message 2 only. However, the UE is going to be allocated a random access preamble from the eNB before transmitting the random access preamble to the eNB as the message 1. And the UE transmits the allocated random access preamble to the eNB as the message 1, and terminates the random access procedure by receiving the random access response from the eNB.

Terms used in this specification are described below.
Dedicated bearer: an EPS bearer associated with an uplink packet filter(s) within a UE and a downlink packet filter(s) within a P-GW. In this case, only a specific packet is matched with the filter(s).
Default bearer: an EPS bearer established even new PDN connection. Context of a default bearer is maintained during the lifetime of a PDN connection.
EPS mobility management (EMM)-EMM-NULL state: an EPS service within a UE is deactivated. Any EPS mobility management function is not performed.
EMM-DEREGISTERED state: in the EMM-DEREGISTERED state, EMM context is not established and an MME is not notified of a UE location. Accordingly, the UE is unreachable by the MME. In order to establish EMM context, the UE needs to start an Attach or combined Attach procedure.
EMM-REGISTERED state: In the EMM-REGISTERED state, EMM context within a UE has been established and default EPS bearer context has been activated. When a UE is in the EMM-IDLE mode, an MME is notified of a UE location with accuracy of a list of TAs including a specific number of a TA. The UE may initiate the transmission and reception of user data and signaling information and may respond to paging. Furthermore, a TAU or combined TAU procedure is performed.
EMM-CONNECTED mode: when an NAS signaling connection is set up between a UE and a network, the UE is the EMM-CONNECTED mode. The term “EMM-CONNECTED” may be referred to as a term “ECM-CONNECTED state.”
EMM-IDLE mode: when an NAS signaling connection is not present between a UE and a network (i.e., an EMM-IDLE mode without suspend indication) or RRC connection suspend is indicated by a lower layer (i.e., an EMM-IDLE mode with suspend indication), the UE is in the EMM-IDLE mode. The term “EMM-IDLE” may be referred to as a term “ECM-IDLE state.”
EMM context: when an Attach procedure is successfully completed, EMM context is established between a UE and an MME.
Control plane CIoT EPS optimization: signaling optimization that enables the efficient transport of user data (IP, non-IP or SMS) through a control plane via an MME. This may optionally include the header compression of IP data.
User plane CIoT EPS optimization: signaling optimization that enables the efficient transport of user data (IP or non-IP) through a user plane.
EPS service(s): a service(s) provided by a PS domain.
NAS signaling connection: a peer-to-peer S1 mode connection between a UE and an MME. An NAS signaling connection has a concatenation of an RRC connection via an LTE-Uu interface and an SlAP connection via an S1 interface.
UE using EPS services with control plane CIoT EPS optimization: UE attached for EPS services with control plane CIOT EPS optimization approved by a network
Non-access stratum (NAS): a functional layer for exchanging an UMTS, signaling between a UE and a core network in an EPS protocol stack, and a traffic message. This has a main function of supporting the mobility of a UE and supporting a session management procedure of establishing and maintaining an IP connection between a UE and a PDN GW.
Access stratum (AS): this means a protocol layer under the NAS layer on the interface protocol between an E-UTRAN (eNB) and a UE or between an E-UTRAN (eNB) and an MME. For example, in the control plane protocol stack, the RRC layer, PDCP layer, RLC layer, MAC layer and PHY layer may be collectively referred to as an AS layer or any one of the layers may be referred to as an AS layer. Or, in the user plane protocol stack, the PDCP layer, RLC layer, MAC layer and PHY layer may be collectively referred to as an AS layer or any one of the layers may be referred to as an AS layer.
S1 mode: a mode applied to a system having functional separation according to the use of an S1 interface between a radio access network and a core network. The S1 mode includes a WB-S1 mode and an NB-S1 mode.
NB-S1 mode: this mode is applied by a UE when a serving radio access network of the UE provides access to a network service (via E-UTRA) based on a narrow band (NB)-Internet of things (IoT).
WB-S1 mode: this mode is applied when a system operates in the S1 mode, but is not the NB-S1 mode.
5G access network: an access network including a 5G radio access network (5G-RAN) and/or a non-5G access network (non-5G-AN) connected to a 5G core network.
5G core network (5GC): a core network connected to a 5G access network.
5G radio access network (5G-RAN): a radio access network having a common characteristic connected to 5GC and supporting one or more of the following options:

1) Standalone new radio.

2) New radio, that is, an anchor supporting an E-UTRA extension.

3) Standalone E-UTRA.

4) Anchor supporting a new radio extension.
5G system (5GS): a 3GPP system consisting of a 5G access network (AN), a 5G core network, and a UE.

Data Volume Indicator/Information

A data volume and power headroom report (DPR) procedure is used to provide a serving eNB with information about the amount of data available within an uplink buffer associated with a MAC entity for transmission. Furthermore, the data volume and power headroom report procedure is used to provide a serving eNB with information about a difference between common UE max transmit power and transmit power estimated for UL-SCH transmission in a serving cell.

The DPR is performed using a DPR MAC control element. The DPR MAC control element is transmitted within a third message (Msg3) along with a common control channel (CCCH) service data unit (SDU).

The Msg 3 is a message transmitted on a UL-SCH including a cell radio network temporary identifier (C-RNTI) MAC control element (CE) or a CCCH SDU (refer to FIG. 6). The C-RNTI MAC CE or CCCH SDU is delivered from a higher layer and is associated with a UE contention resolution identity as part of a random access procedure.

The DPR MAC CE is identified by a MAC packet data unit (PDU) subheader used for the CCCH MAC SDU. Any additional subheader is not added to the DPR MAC CE, and the DPR MAC CE is always placed ahead of a CCCH MAC SDU.

The DPR MAC CE has a fixed size and consists of a single octet. The first 2 bits of the DPR MAC CE are reserved bits, next 2 bits thereof are a power headroom (PH) field, and next 4 bits thereof are a data volume (DV) field in order from the most significant bit (MSB) to the least significant bit (LSB) of the DPR MAC CE.
Data volume (DV): a DV field identifies data available in all of logical channel(s) and a total amount of data not associated with a logical channel after all of MAC PDU(s) for a TTI are produced. The amount of data is indicated as the number of bytes, and includes all of data available for transmission within the RLC layer, the PDCP layer and the RRC layer. The size of RLC and MAC header is not considered in the calculation of the size of a buffer.
Power headroom (PH): this field indicates a power headroom level.
Reserved bits is set to 0.

Small Data Transmission and Data Volume Indicator

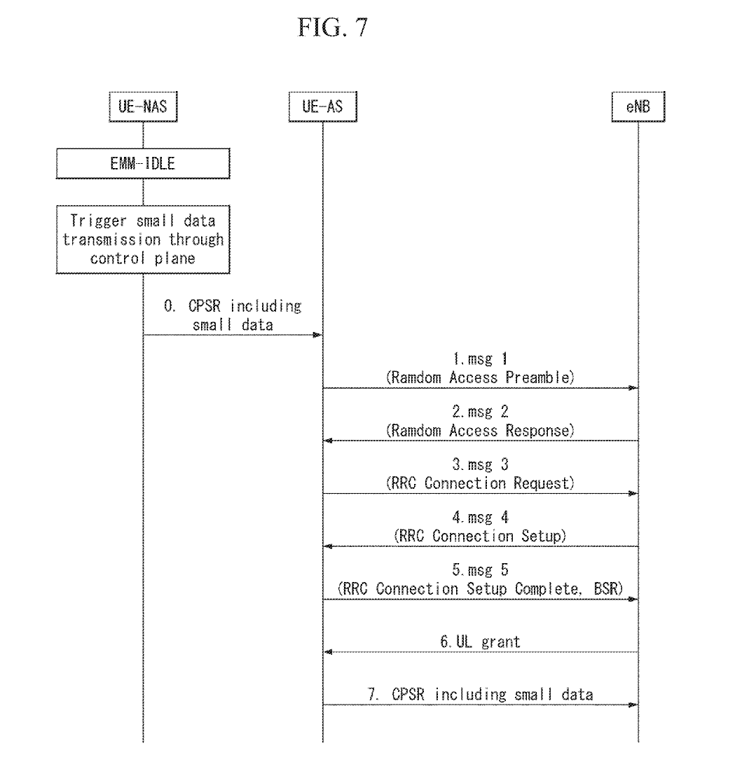

FIG. 7 illustrates a procedure for small data transmission in a wireless communication system to which the present invention may be applied.

0. If the NAS layer of a UE is the EMM-IDLE state, when small data transmission through a control plane (CP) is triggered, the UE-NAS layer delivers, to a UE-AS layer, a control plane service request (CPSR) message including small data.

Msg 1 to Msg 4 illustrated in step 1 to step 4 of FIG. 7 are the same as Msg 1 to Msg 4 of FIG. 6, respectively, and thus a detailed description thereof is omitted.

1. The UE-AS layer transmits a first message (Msg 1) (i.e., a random access preamble) to an eNB.

2. The UE-AS layer receives a second message (Msg 2) (i.e., a random access response) from the eNB.

3. The UE-AS layer transmits a third message (Msg 3) to the eNB.

In this case, the RRC connection request message may be transmitted through Msg 3.

4. The UE-AS layer receives a fourth message (Msg 4) from the eNB.

In this case, an RRC Connection Setup message may be transmitted through Msg 4 as a response to the RRC connection request message.

When the RRC Connection Setup message is received, the UE-AS layer shifts to an RRC_CONNECTED mode.

5. The UE-AS layer transmits a fifth message (Msg 5) to the eNB.

In this case, in order to confirm the successful completion of the RRC connection setup, an RRC Connection Setup Complete message may be transmitted through Msg 5.

Furthermore, in order to transmit small data (i.e., an NAS message including small data, for example, CPSR), the UE-AS may include buffer status reporting (BSR) in Msg 5 and provide it to the eNB.

For efficient use of an uplink radio resource, a base station needs to be aware that each UE should transmit what kind of data to what amount in the uplink. Accordingly, a UE may directly deliver, to a base station, information about uplink data to be transmitted. The base station may allocate an uplink resource to the corresponding UE. In this case, the information about uplink data, delivered from the UE to the base station, is the amount of uplink data stored in the buffer of the UE, which is called a buffer status report (BSR).

6. The eNB confirms the amount of data to be actually transmitted by the UE in the uplink through the BSR, and transmits an uplink grant for a PUSCH resource for actual data transmission to the UE.

7. The UE-AS layer transmits, to the eNB, the actual uplink data (i.e., including the NAS message (e.g., a CSPR including small data) received from the UE-NAS layer) through the PUSCH resource allocated by the eNB.

In FIG. 7, if the eNB is aware of the amount of the NAS message prior to step 5 (e.g., step 3), the UE may obtain an UL grant in step 4 and may transmit the NAS message (e.g., a CSPR including small data) to the eNB in step 5. In this case, the UE can reduce power consumption according to steps 6/7.

Accordingly, a solution (i.e., a data volume indicator (DVI) is defied within Msg3) for reporting the amount of data a radio bearer (RB) that has not yet been established has been defined.

In this specification, the DVI may correspond to the aforementioned DPR MAC CE or may correspond to a DV field within a DPR MAC CE.

This is described with reference to the following drawing.

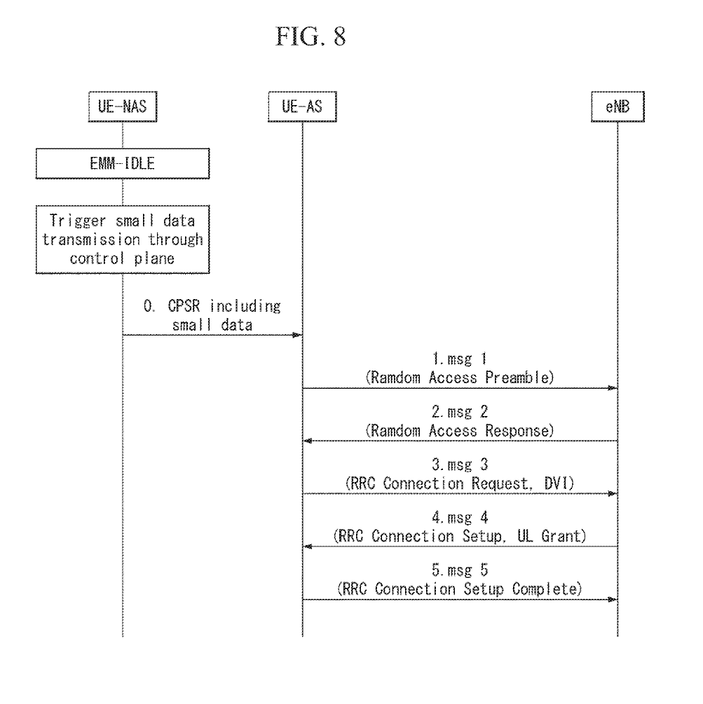

FIG. 8 illustrates a procedure for a data volume report and small data transmission in a wireless communication system to which the present invention may be applied.

0. If the NAS layer of a UE is the EMM-IDLE state, when small data transmission through a control plane (CP) is triggered, the UE-NAS layer delivers, to a UE-AS layer, a control plane service request (CPSR) message including small data.

Msg 1 to Msg 4 illustrated in step 1 to step 4 of FIG. 8 are the same as Msg 1 to Msg 4 of FIG. 6, and thus a detailed description thereof is omitted.

1. The UE-AS layer transmits a first message (Msg 1) (i.e., a random access preamble) to an eNB.

2. The UE-AS layer receives a second message (Msg 2) (i.e., a random access response) from the eNB.

3. The UE-AS layer transmits a third message (Msg 3) to the eNB.

In this case, the RRC connection request message may be transmitted through Msg 3.

Furthermore, a DVI may be transmitted through Msg 3. The DVI may be triggered when a NAS message (e.g., a CSPR including small data) reaches the UE-AS, and may be transmitted through Msg 3.

The DVI may indicate the amount of user data (including an SMS) transmitted through a user plane or control plane and an NAS signaling data volume.

Furthermore, the DVI may be reported as a single number.

4. The eNB confirms the amount of data (i.e., the amount of user data and a data volume of NAS signaling) to be actually transmitted by the UE in the uplink through the DVI, and transmits an uplink grant for a PUSCH resource for actual data transmission to the UE.

5. The UE-AS transmits the actual uplink data to the eNB through the PUSCH resource allocated by the eNB.

In this case, the actual uplink data may include an RRC Connection Setup Complete message for confirming the successful completion of RRC connection setup. Furthermore, the RRC Connection Setup Complete message may include the NAS message (e.g., a CSPR including small data).

As described in FIG. 8, the amount of user data (including an SMS) and a NAS signaling data volume to be transmitted in Msg5 may be transmitted as data volume information (i.e., DVI) within Msg3. Furthermore, if the UE uses a user plane (UP) solution (i.e., cellular Internet of things (CIoT) EPS optimization) or a control plane (CP) solution (i.e., CP CIoT EPS optimization), data volume information (i.e., DVI) may be transmitted. Furthermore, the data volume information (i.e., DVI) may be reported as a single number.

Message for Transmitting Data Through Control Plane

A message for transmitting data to a network through a CP has been defined. This may be referred to as a data service request message or a control plane service request message.

The message newly defined as described above is transmitted from a UE to a network in order to carry an EPS session management (ESM) message within an encapsulated format.

Furthermore, the newly defined message may include an SMS message container for SMS transmission.

Table 2 illustrates content of a data service request message or a control plane service request message.

TABLE 2

| Information | | | | | |
|---|---|---|---|---|---|
| Element | | | | | |
| Identifier (IEI) | Information Element (IE) | Type/Reference | Presence | Format | Length |
| | Protocol discriminator | Protocol discriminator 9.2 | M | V | ½ |
| | Security header type | Security header type 9.3.1 | M | V | ½ |
| | Data service request | Message type 9.8 | M | V | 1 |
| | message identity | | | | |
| | Data service type | Data service type 9.9.3.XX | M | V | ½ |
| | NAS key set identifier | NAS key set identifier 9.9.3.21 | M | V | ½ |
| TBD | ESM message container | ESM message container 9.9.3.15 | O | TLV-E | 3-n |
| TBD | SMS message container | NAS message container 9.9.3.22 | O | TLV | 4-253 |
| 57 | EPS bearer context status | EPS bearer context status 9.9.2.1 | O | TLV | 4 |
| D- | Device properties | Device properties 9.9.2.0A | O | TV | 1 |

In Table 2, IEI indicates the identifier of an IE. The name of the IE is used as a reference for an information element within a message. The type/reference of an IE indicates a paragraph in which a detailed description of a corresponding IE is described in 3GPP TS 24.301 document. Presence indicates whether a corresponding IE is mandatory (M), optional (O) or conditional (C). Format indicates the format of a corresponding IE. Each format is defined in 3GPP TS 24.007. Length indicates the length (or the range of a permitted length) of a corresponding IE.

The use of protocol discriminator (PD) IE and PD is defined in 3GPP TS 24.007. A PD within the header of a security-protected NAS message is encoded as an EPS mobility management (EMM) message.

The security header type IE includes information related to the security protection of a NAS message. A total size of a security header type IE is 4 bits.

The data service request message identity IE indicates a message type. The data service request message identity may be referred to as a control plane service request message identity.

The data service request type IE is used to identify an object of a data service request message. The data service request type IE may be referred to as a control plane service type IE. In this case, the control plane service type IE is used to identify an object of a control plane service request message.

The NAS key set identifier identifies a NAS key set. The NAS key set identifier is allocated by a network.

The ESM message container IE is included in a message when a UE wants to transmit an ESM message to a network.

An object of the ESM message container IE is to enable the piggybacked transmission of a single ESM message within the EMM message. The ESM message container IE may include an ESM message defined in a 3GPP TS 24.301 8.3 EPS session management messages, like a PDN connectivity request message.

The SMS message container IE is included in a message when a UE is the EMM-IDLE mode and has a short message service (SMS) message that is pending for transmission.

The SMS message container IE is used to encapsulate an SMS message transmitted between a UE and a network. The SMS message container IE may include an SMS message defined 3GPP TS 24.011 7.2 paragraph.

The EPS bearer context status IE is included in a message when a UE wants to indicate activated EPS bearer context within the UE.

The EPS bearer context status IE is used to indicate the state of each EPS bearer context that may be identified by an EPS bearer identifier.

The device properties IE is included in a message when NAS signaling low priority is configured in a UE.

Cellular Internet of Things (CIoT) EPS Optimization

A cellular Internet of things (CIoT) has been defined to efficiently service low complexity UEs, such as NB-IoT and LTE MTC. That is, CIoT EPS optimization provides enhanced support for small data transmission.

Control plane (CP) CIoT EPS optimization (or CIoT EPS CP Optimization) and CIoT EPS user plane (UP) optimization (or UP CIoT EPS Optimization) capable of transmitting data through an SRB have now been defined. The two types of different data transmission modes can be supported by the same UE.

1) CP CIoT EPS optimization supports the efficient transport of user data (IP, non-IP or SMS) through a control plane via an MME without triggering data radio bearer establishment. The header compression of IP data may be optimally applied to an IP PDN type PDN connection configured to support header compression.

2) UP CIoT EPS optimization supports a change from the EMM-IDLE mode to the EMM-CONNECTED mode without a need to use a service request procedure.

A main cause of signaling overhead corresponds to a procedure now used in S1-based EPS architecture necessary for UE state transition (i.e., transition between the idle state and the connected state)).

In order to reduce such a related processing load within a network, a solution has been proposed based on reuse of information from a previous RRC connection for the following RRC connection setup.

This function is supported based on an eNB. That is, the resume of a previously suspended connection is limited to a cell(s) configured on an eNB whose connection has been previously suspended. In this case, this solution may be introduced and supported for a UE having transactions over multiple eNBs by introducing a cluster of eNBs that support UE context transport between eNBs through an X2 interface.

A signaling overhead reduction may be realized by two types of the following new procedures, that is, a “Connection Suspend procedure” and a “Connection Resume procedure.”

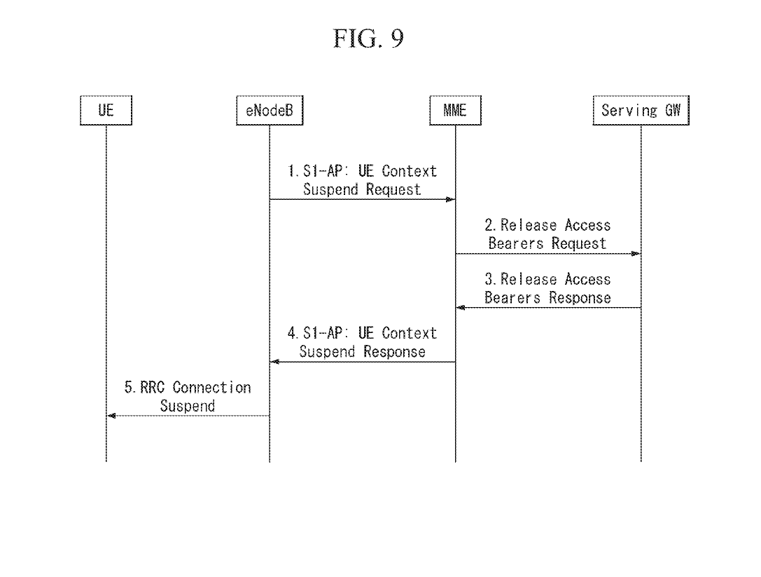

FIG. 9 illustrates a connection suspend procedure initiated by a base station in a wireless communication system to which the present invention may be applied.

If a UE and a network support UP CIoT EPS optimization, this procedure is used to suspend a connection by the network.

1. An eNB initiates a connection suspend procedure with respect to an MME. The eNB indicates that the RRC connection of the UE will be suspended when the MME enters ECM-IDLE with respect to the MME.

Data, UE context and bearer context related to SlAP association necessary to result a connection are maintained in the eNB, the UE and the MME.

The eNB may include information on recommended cells and eNBs for paging in an S1 UE Context Suspend Request message. If this information is available, the MME may store the information in order to use it when the UE performs paging.

If this information is available, the eNB may include information for enhanced coverage in an S1 UE Context Suspend Request message.

2. The MME transmits a Release Access Bearers Request message to the S-GW in order to request the release of all of S1-U (S1 user plane) bearers for the UE.

3. An S-GW releases eNB-related information (i.e., an eNB address and a downlink tunnel endpoint identifier (TEID)(s)) for all of UEs. Furthermore, the S-GW sends a Release Access Bearers Response message to the MME as a response.

Other elements of the S-GW context of the UE are not affected. When a downlink packet for the UE arrives, the S-GW buffers the received downlink packet for the UE and initiates the Network Triggered Service Request procedure (refer to 3GPP TS 23.401).

The S-GW notifies the MME of the release of the S1-U bearer within the Release Access Bearers Response message.

4. The MME transmits the S1-AP UE Context Suspend Response message to the eNB in order to successfully complete the connection suspend procedure initiated by the eNB.

5. The eNB transmits an RRC message to the UE in order to suspend the RRC connection toward the UE.

If a UE NAS has been suspended in the EMM-IDLE state (i.e., if the UE is an EMM-IDLE mode with suspend indication), the UE needs to start a resume procedure in order to transmit uplink signaling or data.

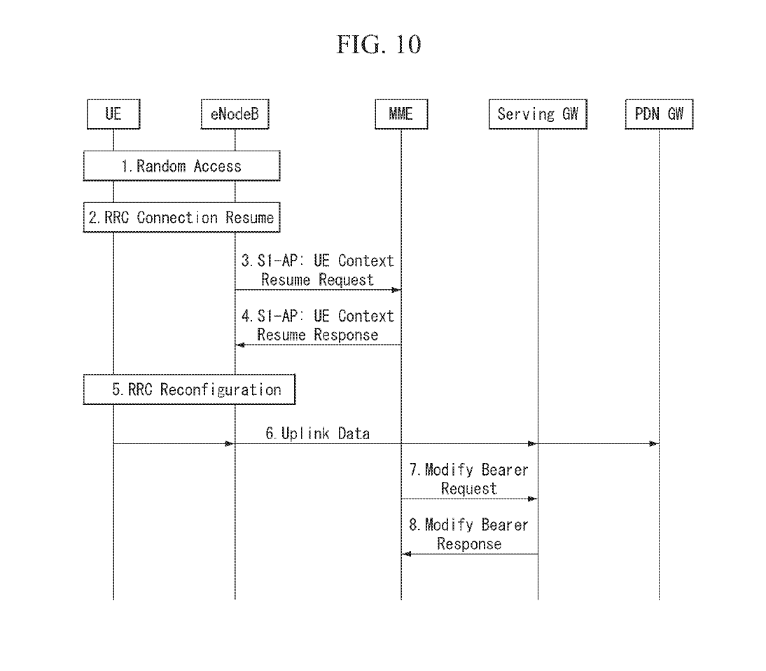

FIG. 10 illustrates a connection resume procedure initiated by a terminal in a wireless communication system to which the present invention may be applied.

If a UE and a network supports UP CIoT EPS optimization and the UE stores information necessary to perform a connection resume procedure, this procedure is used to resume an ECM connection. If not, the Service Request procedure (refer to TS 23.401) is used.

1. A UE triggers a random access procedure (refer to FIG. 6) with respect to an eNB.

2. The UE triggers an RRC Connection Resume procedure including information required by the eNB in order to access the stored AS context of the UE.

An E-UTRAN performs security check.

EPS bearer state synchronization is performed between the UE and the network. That is, a radio bearer is not established in the UE, and the UE locally deletes an EPS bearer not a CP CIoT EPS bearer. If a radio bearer for a default EPS bearer is not established, the UE locally deactivates all of EPS bearers associated with the default EPS bearer.

3. The eNB notifies an MME that the RRC connection of the UE has been resumed within an S1-AP UE Context Resume Request message including a RRC resume cause. If the eNB cannot admit all of suspended bearers, the eNB indicates this within a list of rejected EPS bearers. The MME enters the ECM-CONNECTED state. The MME identifies whether the UE has returned to the eNB for the MME in which bearer context including data, UE context and DL TEID associated with SlAP association necessary to resume a connection has been stored.

If the default EPS bearer is not accepted by the eNB, all of EPS bearers associated with the default bearer are treated as non-accepted bearers. The MME releases non-accepted bearers and non-established bearers by triggering the bearer release procedure (refer to TS 24.301).

In order to assist a location service, the eNB indicates the coverage level of the UE with respect to the MME.

4. The MME acknowledges connection resume within an S1-AP UE Context Resume Response message. If the MME cannot admit all of suspended E-RABs, the MME indicates this within an E-RABs Failed To Resume List information element (IE).

5. If the MME has included an E-RABs Failed To Resume List in step 4, the eNB reconfigures a radio bearer.

6. Uplink data may be delivered from the UE to an S-GW by the eNB. The eNB transmits the uplink data to the S-GW using the S-GW address and TEID stored during the connection suspend procedure. The S-GW delivers the uplink data to a P-GW.

7. The MME transmits a Modify Bearer Request message to the S-GW for each PDN connection. The Modify Bearer Request message may include an eNB address, an S1 TEID for an accepted EPS bearer, a delay downlink packet notification request, and an RAT type.

Now the S-GW can transmit downlink data to the UE.

In order to memorize that which downlink data buffered for a UE using a power saving function, has been delivered and to prevent unnecessary user plane setup along with a subsequent TAU, the MME and the S-GW clear a DL Data Buffer Expiration Time within their UE context (if set).

8. The S-GW returns a Modify Bearer Response message to the MME as a response to the Modify Bearer Request message.

The Modify Bearer Response message may include an S-GW address and a TEID for uplink traffic.

Hereinafter, step 2 of FIG. 10, that is, the RRC Connection Resume procedure, is described more specifically.

When the UE has UE AS context, RRC Connection Resume is admitted by the E-UTRAN, and the UE needs to make transition from the RRC_IDLE state to the RRC_CONNECTED state, the resume of a suspended RRC connection is initiated by a higher layer (i.e., NAS layer).

When the RRC connection is resumed, an RRC layer configures the UE according to an RRC Connection Resume procedure based on stored UE AS context and an RRC configuration received from the E-UTRAN. The RRC Connection Resume procedure activates security again and reestablishes an SRB(s) and a DRB(s). The resume request of the RRC connection includes a resume identifier (resumeIdentity).

FIG. 11 illustrates an RRC connection resume procedure in a wireless communication system to which the present invention may be applied.

FIG. 11(a) illustrates the successful resume of an RRC connection.

Referring to FIG. 11(a), a UE (i.e., UE AS layer) transmits an RRC Connection Resume Request message to an E-UTRAN (e.g., eNB) in order to request the resume of a suspended RRC connection (S1101a).

When an initial NAS message is generated, a UE NAS layer suspends a corresponding initial NAS message and transmits only an RRC establishment cause and a call type to the UE AS layer (i.e., a lower layer). As described above, when the RRC establishment cause and the call type are received from the NAS layer, the UE AS layer transmits the RRC Connection Resume Request message to the E-UTRAN.

The UE (i.e., UE AS layer) receives an RRC Connection Resume message for resuming the suspended RRC connection from the E-UTRAN as a response to the RRC Connection Resume Request message (S1102a).

When the RRC Connection Resume message is received, the UE enters an RRC_CONNECTED state. Furthermore, when the RRC Connection Resume message is received, the UE AS layer indicates that the suspended RRC connection has been resumed with respect to a higher layer (i.e., NAS layer).

The UE (i.e., UE AS layer) transmits an RRC Connection Resume Complete message to the E-UTRAN in order to confirm the successful completion of the resume of the RRC connection (S1103a).

FIG. 11(b) illustrates the resume of an RRC connection rejected or released by a network.

Referring to FIG. 11(b), a UE (i.e., UE AS layer) transmits an RRC Connection Resume Request message to an E-UTRAN (e.g., eNB) in order to request the resume of a suspended RRC connection (S1101b).

The UE (i.e., UE AS layer) receives an RRC Connection Reject message for rejecting RRC connection setup from the E-UTRAN as a response to the RRC Connection Resume Request message (S1102a).

When the RRC Connection Resume message is received, the UE AS layer notifies a higher layer (i.e., NAS layer) of a failure of the resume of the RRC connection.

Hereinafter, an operation of the NAS layer of a UE is described more specifically.

When an initial NAS message is generated, a UE NAS layer suspends the corresponding initial NAS message and transmits only an RRC establishment cause and a call type to a UE AS layer (i.e., a lower layer).

The UE AS layer performs the resume of an RRC connection as in step 2 of FIG. 10 and notifies the UE NAS layer of the success or failure of the resume. When the UE AS layer notifies the UE NAS layer of the success of the resume, the UE NAS layer determines whether to deliver the initial NAS message to the UE AS depending on the type of pending initial NAS message. If the initial NAS message needs to be delivered, the UE NAS layer delivers the initial NAS message to the UE AS. If not, the UE NAS layer discards the corresponding initial NAS message.

If UP EPS optimization is used, the suspend of an NAS signaling connection may be initiated by a network in the EMM-CONNECTED mode. The resume of the suspended NAS signaling connection is initiated by a UE.

When UP EPS optimization is used within a UE:
When indication informing that an RRC connection has been suspended is received from a lower layer, the UE enter an EMM-IDLE mode with suspend indication, but does not consider that an NAS signaling connection has been released;
When a procedure using an initial NAS message is triggered during the EMM-IDLE mode with suspend indication, the UE requests the resume of the RRC connection from the lower layer. The NAS layer provides an RRC establishment cause and a call type to the lower layer within the request toward the lower layer;
When the lower layer indicates that the RRC connection has been resumed during the EMM-IDLE mode with suspend indication, the UE enters the EMM-CONNECTED mode. When a service request message is pending, the UE does not transmit the corresponding message. When an initial NAS message different from a SERVICE REQUEST message is pending, the corresponding message is transmitted. In this case, when the NAS message is discarded and is not transmitted to a network, an uplink NAS count value corresponding to the corresponding message is reused when a next uplink NAS message is transmitted; and
When the lower layer indicates that the resume of the RRC connection has failed during the EMM-IDLE mode with suspend indication, the UE enters an EMM-IDLE mode without suspend indication and transmits any pending initial NAS message or restarts an ongoing NAS procedure.

When UP EPS optimization is used within a network:
When a lower layer indicates that an RRC connection has been suspended, the network enters an EMM-IDLE mode with suspend indication, but does not consider that an NAS signaling connection has been released; and
When the lower layer indicates that the RRC connection has been resumed during the EMM-IDLE mode with suspend indication, the network enters an EMM-CONNECTED mode.

Data Volume Information Report Method

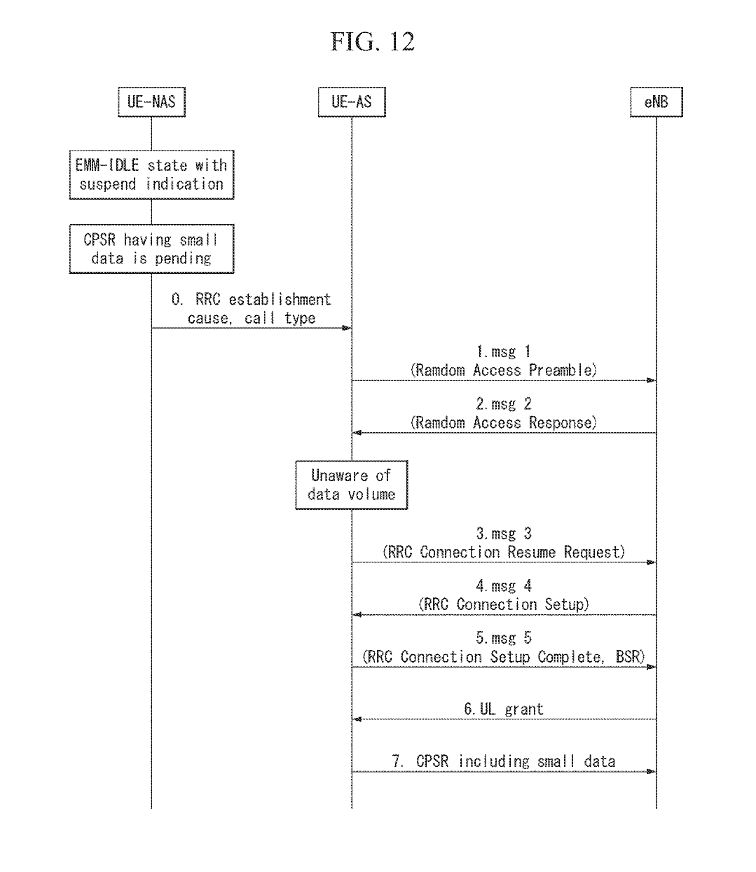

FIG. 12 is a diagram for illustrating problems of a connection resume procedure in a wireless communication system to which the present invention may be applied.

0. If the NAS layer of a UE is in an EMM-IDLE state with suspend indication, when a CPSR having small data is triggered, the NAS layer of the UE suspends the CPSR and delivers only an RRC establishment cause and a call type to a UE AS layer.

Msg 1 to Msg 4 illustrated in step 1 to step 4 of FIG. 12 are the same as Msg 1 to Msg 4 of FIG. 6, and thus a detailed description thereof is omitted.

1. The UE-AS layer transmits a first message (Msg 1) (i.e., a random access preamble) to an eNB.

2. The UE-AS layer receives a second message (Msg 2) (i.e., a random access response) from the eNB.

3. In this case, the UE AS layer cannot be aware of a data volume to be transmitted in Msg5. Accordingly, there is a problem in that a data volume indicator/information cannot be transmitted through Msg3.

As a result, the UE-AS layer transmits a third message (Msg 3), not including a data volume indicator/information, to the eNB.

In this case, an RRC Connection Resume Request message may be transmitted through Msg 3.

4. The UE-AS layer receives a fourth message (Msg 4) from the eNB.

In this case, an RRC Connection Setup message may be transmitted through Msg 4 as a response to the RRC Connection Request message.

When the RRC Connection Setup message is received, the UE-AS layer makes transition to an RRC_CONNECTED mode.

5. The UE-AS layer transmits a fifth message (Msg 5) to the eNB.

In this case, in order to confirm the successful completion of the RRC connection setup, an RRC Connection Setup Complete message may be transmitted through Msg 5.

Furthermore, in order to transmit small data (i.e., an NAS message including small data, for example, CPSR), the UE-AS may include buffer status reporting (BSR) in Msg 5 and provide it to the eNB.

6. The eNB confirms the amount of data to be actually transmitted by the UE in the uplink through the BSR, and transmits an uplink grant (UL grant) for a PUSCH resource for the actual data transmission to the UE.

7. The UE-AS transmits the actual uplink data (i.e., an NAS message (e.g., a CSPR including small data) received from the UE-NAS) to the eNB through the PUSCH resource allocated by the eNB.

As described in FIG. 8, in order to transmit the NAS message (e.g., a CSPR including small data) through Msg5, a data volume indicator must be included in Msg3 and transmitted to the eNB.

However, as described in FIG. 12, when the resume of a suspended NAS signaling connection is requested (i.e., when a procedure using an initial NAS message is triggered), the NAS layer does not deliver the initial NAS message to a lower layer (e.g., RRC layer). Accordingly, the lower layer cannot be aware of data volume information of the NAS message when it transmits Msg3, and thus cannot transmit a data volume indicator to the eNB through Msg3. As a result, there is a problem in that signaling overhead increases because the UE inevitably transmits the initial NAS message through Msg7.

In order to solve such a problem, the present invention proposes a method for a UE NAS layer to deliver data volume information to a UE AS layer so that the UE AS layer can transmit a data volume indicator (or data volume indication/information) through Msg3 when the UE is an EMM-IDLE mode with suspend indication.

That is, in the state in which the UE is the EMM-IDLE mode with a suspend indication, when the triggering of an initial NAS message occurs (i.e., when a procedure using an initial NAS message is triggered), the NAS layer of the UE transmits, to the AS layer (e.g., RRC layer) of the UE, a request to resume an RRC connection. In this case, the request to resume the RRC connection may include an RRC establishment cause, a call type, and data volume information of a pending initial NAS message.

In this case, the initial NAS message may include a data service request message used to transmit user data over a control plane.

The data service request message means a message for transmitting user data (e.g., small data, including an SMS message) over the control plane, and may be referred to as a control plane service request message.

In this case, the data service request message may be used when a UE uses CP CIoT EPS optimization.

In this case, the data volume information may indicate a pure data size or may indicate a total size of the data service request message. Furthermore, the data volume information may indicate the size of the initial NAS message.

The pure data size may mean the size of a container (i.e., an ESM message container or SMS message container) including user data or may mean an actual data size within the container.

Furthermore, the initial NAS message may include an ATTACH REQUEST message, a DETACH REQUEST message, a TRACKING AREA UPDATE REQUEST message, a SERVICE REQUEST message, and an EXTENDED SERVICE REQUEST message.

### Embodiment 1

When UP EPS optimization is used, the suspend of an NAS signaling connection may be initiated by a network in an EMM-CONNECTED mode. The resume of the suspended NAS signaling connection is initiated by a UE.

When UP EPS optimization is used, a UE (e.g., within the NAS layer of the UE) may perform the following operation.
When indication informing that an RRC connection has been suspended is received from a lower layer (e.g., RRC layer), the UE enters an EMM-IDLE mode with suspend indication, but may not consider that an NAS signaling connection has been released.

The indication informing that the RRC connection has been suspended may be delivered to the NAS layer of the UE when a release cause (releaseCause) within an RRC Connection Release message received by the lower layer (e.g., RRC layer) of the UE from the eNB indicates RRC suspend (rrc-Suspend).
When a procedure using an initial NAS message is triggered during the EMM-IDLE mode with suspend indication, the resume of the RRC connection may be requested from the lower layer (e.g., RRC layer).

The NAS layer may provide the lower layer with data volume information of the NAS message, an RRC establishment cause, and a call type within the request toward the lower layer (e.g., RRC layer).
When indication informing that the RRC connection has been resumed is received from the lower layer (e.g., RRC layer) during the EMM-IDLE mode with suspend indication, the UE may enter an EMM-CONNECTED mode.

The indication informing that the RRC connection has been resumed may be delivered to the NAS layer of the UE when the lower layer (e.g., RRC layer) of the UE receives an RRC Connection Resume message from an eNB.

In this case, when a service request message is pending, the corresponding message may not be transmitted to the lower layer. In contrast, when an initial NAS message different from the service request message is pending, the corresponding message may be transmitted to the lower layer.

In this case, when the NAS message is discarded and is not transmitted to a network, an NAS count value corresponding to the corresponding message may be reused when a next uplink NAS message is transmitted.
When indication informing that the resume of the RRC connection has been fallen back is received from the lower layer (e.g., RRC layer) during the EMM-IDLE mode with suspend indication, the UE may enter an EMM-IDLE mode without suspend indication. Furthermore, the UE may transmit any pending initial NAS message to the lower layer, and may perform the same procedure as that when RRC connection setup has been requested.

The indication informing that the resume of the RRC connection has been fallen back may be delivered to the NAS layer of the UE when the lower layer (e.g., RRC layer) of the UE receives the RRC Connection Setup message from the eNB.

Referring back to FIG. 11, the UE AS layer may transmit an RRC Connection Resume Request message to the eNB. Furthermore, when the UE AS layer receives an RRC Connection Setup message from the eNB as a response to the RRC Connection Resume Request message, it may transmit indication informing that the resume of the RRC connection has been fallen back to the UE NAS layer.
When indication informing that the resume of the RRC connection has failed and indication informing that an RRC connection is to be suspended are received from the lower layer (e.g., RRC layer), the UE enters an EMM-IDLE mode with suspend indication and may resume an ongoing NAS procedure (if requested).
When indication informing that the resume of the RRC connection has failed and indication informing that an RRC connection is not suspended are received from the lower layer (e.g., RRC layer), the UE enters an EMM-IDLE mode without suspend indication and may resume an ongoing NAS procedure (if requested).

The indication informing that the resume of the RRC connection has failed may be delivered to the NAS layer of the UE when the lower layer (e.g., RRC layer) of the UE receives an RRC Connection Reject message from an eNB.

When UP EPS optimization is used, a network (e.g., the NAS layer of a network (e.g., MME) may perform the following operation:
When the lower layer indicates that RRC connection has been suspended, a network enters an EMM-IDLE mode with suspend indication, but may not consider that an NAS signaling connection has been released.
When the lower layer indicates that an RRC connection has been resumed during an EMM-IDLE mode with suspend indication, a network may enter an EMM-CONNECTED mode.

Meanwhile, the operation of transmitting the data volume indicator/information (or an operation of reporting a data volume and power headroom report) from the NAS layer to the lower layer (i.e., the AS layer, for example, the RRC layer) may be applied to the NB-IoT RAT (or NB-S1 mode) only. Furthermore, the operation may not be applied to the E-UTRAN RAT (or WB-S1 mode).

That is, the operation of transmitting the data volume indicator from the NAS layer to the lower layer (i.e., the AS layer, for example, the RRC layer) may be applied only when the UE is served by the NB-IoT RAT (or when the UE is the NB-S1 (or NB-IoT) mode). Furthermore, the operation may not be applied when the UE is served by the E-UTRAN RAT (or when the UE is the WB-S1 mode).

The reason why the operation is limited to the NB-IoT RAT (or NB-S1 (or NB-IoT) mode) only as described above is that power saving of an NB-IoT UE (i.e., a UE attached to the NB-IoT RAT or a UE to which the NB-S1 (or NB-IoT) mode is applied) is more important. Accordingly, the reason for this is that the NB-IoT UE can reduce the number of transmission Msgs and an operation of rapidly terminating Msg transmission and entering the EMM-IDLE (or RRC-IDLE) has a greater influence for power saving of a UE compared to an E-UTRAN (i.e., a UE to which the WB-S1 mode is applied).

Accordingly, if the operation of transmitting the data volume indicator/information from the NAS layer to the lower layer (i.e., the AS layer, for example, the RRC layer) is applied to the NB-IoT RAT (or NB-S1 (or NB-IoT) mode) only, the following two implementation methods may be taken into consideration.

First, the NAS layer of a UE may provide data volume information of a pending initial NAS message to the AS layer of the UE regardless of a serving RAT of the UE (or a mode of the UE). Furthermore, the AS layer of the UE may be used for only the NB-IoT RAT (or NB-S1 (or NB-IoT) mode). In this case, the method according to the embodiment 1 may be used.

Second, the NAS layer of a UE may provide data volume information of a pending initial NAS message to the AS layer of the UE only in the NB-IoT RAT (or NB-S1 (or NB-IoT) mode). In this case, the method according to an embodiment 2 to be described below may be used.

### Embodiment 2

When UP EPS optimization is used, the suspend of an NAS signaling connection may be initiated by a network in the EMM-CONNECTED mode. The resume of a suspended NAS signaling connection is initiated by a UE.

When UP EPS optimization is used, a UE (e.g., within the NAS layer of the UE) may perform the following operation.
When indication informing that an RRC connection has been suspended is received from a lower layer (e.g., RRC layer), a UE enters an EMM-IDLE mode with suspend indication, but may not consider that an NAS signaling connection has been released.

Indication informing that an RRC connection has been suspended may be delivered to the NAS layer of a UE when a release cause (releaseCause) within an RRC Connection Release message received by the lower layer (e.g., RRC layer) of the UE from an eNB indicates RRC suspend (rrc-Suspend).
When a procedure using an initial NAS message is triggered during an EMM-IDLE mode with suspend indication, the resume of the RRC connection may be requested from a lower layer (e.g., RRC layer).

The NAS may provide the lower layer with an RRC establishment cause and a call type within the request toward the lower layer (e.g., RRC layer).

In this case, if the UE is the NB-S1 mode, the NAS layer of the UE may additionally provide the lower layer (e.g., RRC layer) with data volume information of the NAS message within the request toward the lower layer.
When indication informing that an RRC connection has been resumed is received from the lower layer (e.g., RRC layer) during the EMM-IDLE mode with suspend indication, the UE may enter the EMM-CONNECTED mode.

The indication informing that the RRC connection has been resumed may be delivered to the NAS layer of the UE when the lower layer (e.g., RRC layer) of the UE receives an RRC Connection Resume message from the eNB.

In this case, when a service request message is pending, the corresponding message may not be transmitted to the lower layer. In contrast, when an initial NAS message different from the service request message is pending, the corresponding message may be transmitted to the lower layer.

In this case, when then NAS message is discarded and is not transmitted to a network, an NAS count value corresponding to the corresponding message may be reused when a next uplink NAS message is transmitted.
When indication informing that the resume of the RRC connection has been fallen back is received from the lower layer (e.g., RRC layer) during the EMM-IDLE mode with suspend indication, the UE may enter an EMM-IDLE mode without suspend indication. Furthermore, the UE transmits any pending initial NAS message to the lower layer, and may perform the same procedure as that when RRC connection setup has been requested.

The indication informing that the resume of the RRC connection has been fallen back may be delivered to the NAS layer of the UE when the lower layer (e.g., RRC layer) of the UE receives an RRC Connection Setup message from the eNB.

Referring back to FIG. 11, the UE AS layer may transmit the RRC Connection Resume Request message to the eNB. Furthermore, when the UE AS layer receives an RRC Connection Setup message from the eNB as a response to the RRC Connection Resume Request message, it may transmit indication informing that the resume of the RRC connection has been fallen back to the UE NAS layer.
When indication informing that the resume of the RRC connection has failed and indication informing that an RRC connection will be suspended are received from a lower layer (e.g., RRC layer), the UE enters an EMM-IDLE mode with suspend indication and may resume an ongoing NAS procedure (if requested).
When indication informing that the resume of the RRC connection has failed and indication informing that the RRC connection will not be suspended are received from the lower layer (e.g., RRC layer), the UE enters an EMM-IDLE mode without suspend indication and may resume an ongoing NAS procedure (if requested).

The indication informing that the resume of the RRC connection has failed may be delivered to the NAS layer of the UE when the lower layer (e.g., RRC layer) of the UE receives an RRC Connection Reject message from the eNB.

When UP EPS optimization is used, a network (e.g., the NAS layer of a network (e.g., MME)) may perform the following operation:
When the lower layer indicates that an RRC connection has been suspended, the network enters an EMM-IDLE mode with suspend indication, but may not consider that an NAS signaling connection has been released.
When the lower layer indicates that the RRC connection has been resumed during the EMM-IDLE mode with suspend indication, the network may enter an EMM-CONNECTED mode.

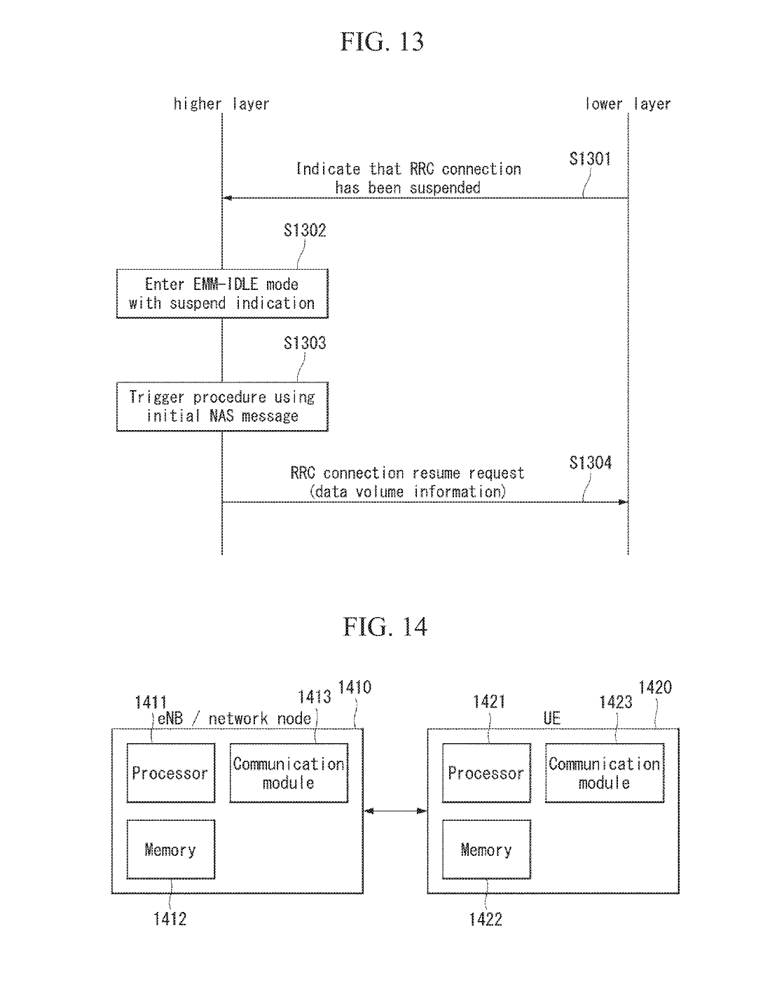

FIG. 13 is a diagram illustrating a method for a UE to suspend/resume NAS signaling according to an embodiment of the present invention.

In FIG. 13, the higher layer of the UE may be an NAS layer, and the lower layer thereof may be an AS layer (e.g., RRC layer).

When the higher layer of the UE receives indication, informing that an RRC connection has been suspended, from the lower layer (S1301), the higher layer of the UE enters an EMM-IDLE mode with suspend indication (S1302).

When a procedure using an initial NAS message is triggered (S1303), the higher layer of the UE requests the resume of the RRC connection from the lower layer (S1304).

In this case, the request for the resume of the RRC connection may include an RRC establishment cause and a call type.

Furthermore, when the UE is the NB-S1 mode, the request for the resume of the RRC connection may further include data volume information of the NAS message.

The initial NAS message may include a first message (e.g., a data service request message or a control plane service request message) for transmitting data over a control plane.

In this case, the data volume information may indicate the size of the data, the size of the first message. Or, the data volume information may indicate the size of an EPS session management (ESM) message container including an ESM message or the size of an SMS message container including a short message service (SMS) message within the first message.

Thereafter, if the UE is an EMM-IDLE mode with suspend indication, when it receives indication informing that the RRC connection has been resumed from the lower layer, the UE may enter an EMM-CONNECTED mode.

In this case, if the initial NAS message is a service request message, the initial NAS message is not delivered to the lower layer. If the initial NAS message is not a service request message, the initial NAS message may be delivered to the lower layer.

Furthermore, while the UE is the EMM-IDLE mode with suspend indication, when the UE receives indication, informing that the resume of the RRC connection has been fallen back, from the lower layer, the UE may enter an EMM-IDLE mode without suspend indication.

In this case, the initial NAS message may be delivered to the lower layer.

Furthermore, while the UE is the EMM-IDLE mode with suspend indication, when the UE receives indication informing that the resume of the RRC connection has failed from the lower layer whose RRC connection has been suspended, the UE may enter an EMM-IDLE mode with suspend indication.

Furthermore, while the UE is the EMM-IDLE mode with suspend indication, when the UE receives indication informing that the resume of the RRC connection has failed from the lower layer whose RRC connection has not been suspended, the UE may enter an EMM-IDLE mode without suspend indication.

Overview of Devices to which the Present Invention can be Applied

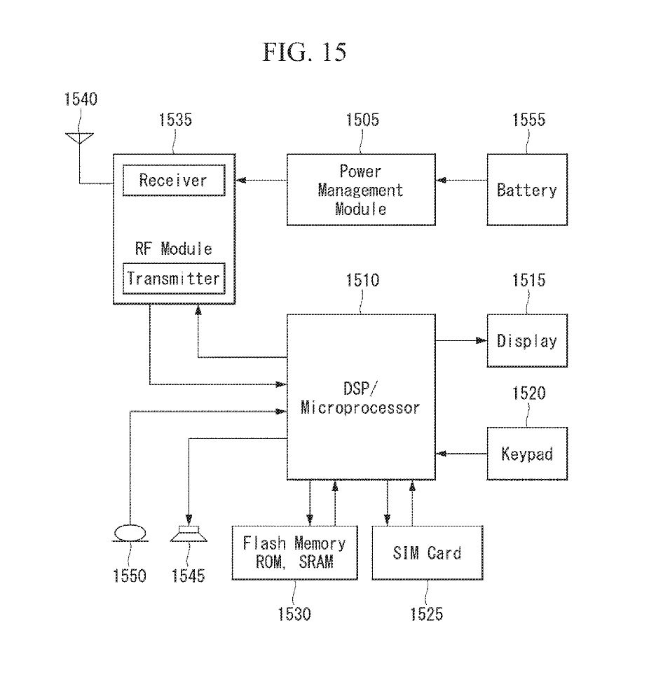

FIG. 14 illustrates a block diagram of a communication device according to one embodiment of the present invention.

Referring to FIG. 14, a wireless communication system includes a network node 1410 and a plurality of UEs 1420.

A network node 1410 includes a processor 1411, memory 1412, and a communication module 1413. The processor 1411 implements the functions, processes and/or methods proposed in FIGS. 1 to 13. The processor 1411 may implement the layers of a wired/wireless interface protocol.

The memory 1412 is connected to the processor 1411, and stores various types of information for driving the processor 1411. The communication module 1413 is connected to the processor 1411, and transmits and/or receives wired/wireless signals. Examples of the network node 1410 include an eNB, MME, HSS, SGW, PGW, application server and so on. In particular, if the network node 1410 is an eNB, the communication module 1413 may include a radio frequency (RF) unit for transmitting and receiving radio signals.

The UE 1420 includes a processor 1421, memory 1422, and a communication module (or RF unit) 1423. The processor 1421 implements the functions, processes and/or methods proposed in FIGS. 1 to 13. The processor 1421 may implement the layers of a wireless interface protocol. In particular, the processor may include a NAS layer and an AS layer. The memory 1422 is connected to the processor 1421, and stores various types of information for driving the processor 1421. The communication module 1423 is connected to the processor 1421, and transmits and/or receives wired/wireless signals.

The memory 1412, 1422 may be positioned inside or outside the processor 1411, 1421 and may be connected to the processor 1411, 1421 through various well-known means. Also, the network node 1410 (in the case of an eNB) and/or the UE 1420 may have a single antenna or multiple antennas.

FIG. 15 illustrates a block diagram of a wireless communication apparatus according to an embodiment of the present invention.

Particularly, in FIG. 15, the UE described in FIG. 14 is illustrated more specifically.

Referring to FIG. 15, the UE includes a processor (or digital signal processor) 1510, an RF module (RF unit) 1535, a power management module 1505, an antenna 1540, a battery 1555, a display 1515, a keypad 1520, memory 1530, a subscriber identification module (SIM) card 1525 (this may be optional), a speaker 1545 and a microphone 1550. The UE may include a single antenna or multiple antennas.

The processor 1510 may be configured to implement the functions, procedures and/or methods proposed in the present invention in FIG. 1-13. The layers of a wireless interface protocol may be implemented by the processor 1510.

The memory 1530 is connected to the processor 1510 and stores information related to operations of the processor 1510. The memory 1530 may be positioned inside or outside the processor 1510 and may be connected to the processors 1510 through various well-known means.

A user enters instruction information, such as a telephone number, by pushing the buttons of a keypad 1520 or by voice activation using the microphone 1550, for example. The microprocessor 1510 receives and processes the instruction information to perform an appropriate function, such as to dial a telephone number. Operational data may be retrieved from the SIM card 1525 or the memory module 1530 to perform the function. Furthermore, the processor 1510 may display the instructional and operational information on the display 1515 for the user's reference and convenience.

The RF module 1535 is connected to the processor 1510, transmits and/or receives an RF signal. The processor 1510 issues instructional information to the RF module 1535, to initiate communication, for example, transmits radio signals comprising voice communication data. The RF module 1535 includes a receiver and a transmitter to receive and transmit radio signals. An antenna 1540 facilitates the transmission and reception of radio signals. Upon receiving radio signals, the RF module 1535 may forward and convert the signals to baseband frequency for processing by the processor 1510. The processed signals would be transformed into audible or readable information outputted via the speaker 1545.

The aforementioned embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments of the present invention may be achieved by various means, for example, hardware, firmware, software, or a combination thereof. In a hardware configuration, the methods according to the embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present invention may be implemented in the form of a module, a procedure, a function, etc. Software code may be stored in a memory unit and executed by a processor. The memory unit may be located at the interior or exterior of the processor and may transmit data to and receive data from the processor via various known means.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The present invention is applied to a 3GPP LTE/LTE-A system is primarily described, but may be applied to various wireless communication systems, particularly 5G (S generation) systems, in addition to the 3GPP LTE/LTE-A system.

1. A method for a user equipment (UE) to suspend and resume a non-access stratum (NAS) signaling connection in a wireless communication system, the method comprising:
entering, by the UE, an evolved packet system (EPS) mobility management (EMM)-IDLE mode with suspend indication when an NAS layer of the UE receives information informing that an RRC connection has been suspended from a radio resource control (RRC) layer; and
requesting resume of an RRC connection from the RRC layer of the UE when a procedure using an initial NAS message is triggered,
wherein the request comprises an RRC establishment cause and a call type, and
when the UE is in a narrow band (NB)-S1 mode, the request further comprises data volume information of the initial NAS message.

2. The method of claim 1, wherein the initial NAS message comprises a first message for transmitting data over a control plane.

3. The method of claim 1, wherein the data volume information informs a size of the data or a size of the initial NAS message.

4. The method of claim 2, wherein the data volume information informs a size of an ESM message container comprising an EPS session management (ESM) message or a size of an SMS message container comprising a short message service (SMS) message within the first message.

5. The method of claim 1, wherein while the UE is the EMM-IDLE mode with suspend indication, when the information informing that the RRC connection has been resumed is received from the RRC layer, the UE enters an EMM-CONNECTED mode.

6. The method of claim 5, wherein when the initial NAS message is a service request message, the initial NAS message is not delivered to the RRC layer.

7. The method of claim 5, wherein when the initial NAS message is not a service request message, the initial NAS message is delivered to the RRC layer.

8. The method of claim 1, wherein while the UE is the EMM-IDLE mode with suspend indication, when information informing that the resume of the RRC connection has been fallen back is received from the RRC layer, the UE enters an EMM-IDLE mode without suspend indication.

9. The method of claim 8, wherein the initial NAS message is delivered to the RRC layer.

10. The method of claim 1, wherein when information informing that the resume of the RRC connection has failed and information informing that the RRC connection is to be suspended are received from the RRC layer, the UE enters the EMM-IDLE mode with suspend indication.

11. The method of claim 1, wherein when information informing that the resume of the RRC connection has failed and information informing that the RRC connection is not suspended are received from the RRC layer, the UE enters an EMM-IDLE mode without suspend indication.

12. A user equipment (UE) for suspending/resuming a non-access stratum (NAS) signaling connection in a wireless communication system, the UE comprising:
a communication module for transmitting and receiving signals; and
a processor controlling the communication module,
wherein the processor is configured to:
enter an evolved packet system (EPS) mobility management (EMM)-IDLE mode with suspend indication when an NAS layer of the UE receives information informing that an RRC connection has been suspended from a radio resource control (RRC) layer; and
request resume of an RRC connection from the RRC layer of the UE when a procedure using an initial NAS message is triggered,
wherein the request comprises an RRC establishment cause and a call type, and
when the UE is in a narrow band (NB)-S1 mode, the request further comprises data volume information of the initial NAS message.
